(19) United States
(12) Patent Application Publication
(10) Pub. No.: US 2003/0210264 A1
(43) Pub. Date: Nov. 13, 2003

(54) Method and system for creating a corporate entity

(76) Inventor: Neal William Macrossan, Brisbane (AU)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/445,092

(22) Filed: May 23, 2003

Related U.S. Application Data
(63) Continuation of application No. PCT/AU01/01526, filed on Nov. 23, 2001.

(30) Foreign Application Priority Data
Nov. 23, 2000 (AU) PR 1654

(51) Int. Cl. G09G 5/00

(52) U.S. Cl. 345/751

(57) ABSTRACT

A method for assisting in the formation of a corporate entity, in an answering session, the method comprising the steps of: (a) interactively communicating via an interactive communications device, a series of questions to a user attempting to establish the corporate entity; (b) permitting the user to provide an answer to the set of one or more questions; (c) successively selecting a further set of one or more questions for display to the user, at least one of the selection being dependent upon the user's previous answer or combination of previous answers; (d) permitting the user to answer the successive set of one or more selected questions; (e) repeating steps (c) to (d) until the user has provided enough information to allow for the determination as to which documents are legally required for the formation of the corporate entity; and (f) generating the legally required documents referred to in step (e) in an electronic form.

### CROSS-REFERENCE TO RELATED APPLICATIONS

The present patent application is a continuation of prior International Patent Application No. PCT/AU01/01526, which claims priority from Australian Patent Application No. PR 1654, filed on Nov. 23, 2000.

### FIELD OF THE INVENTION

The present invention relates to a method and system for creating a corporate entity.

### BACKGROUND OF THE INVENTION

Creating a corporate entity can be a somewhat time consuming, labour intensive, intricate, and costly exercise requiring a degree of skill and expertise. Also, this process often requires person(s) seeking to create the entity to gather and provide a significant amount of information in order to satisfy the legal requirements for creating a corporate entity. Usually person(s) (including lawyers and accountants acting in their professional capacity) seeking to form a corporate entity may do so by:

purchasing an existing, pre-formed dormant corporation “off the shelf” from a shelf company provider, lawyer, or accountant (‘option 1’);

engaging the services of a shelf company provider, lawyer, or accountant to incorporate the new corporation (‘option 2’); or

attempting to do it themselves after seeking whatever limited, static and non interactive guidance they may require and be able to obtain (‘option 3’).

The disadvantage with the above procedures is that, in the case of options 1 and 2, the ‘client’ will require the services of a professional service provider. This can be somewhat costly, involves communicating with the professional service provider and frequently involves meeting with the professional service provider for the purposes of receiving advice and signing documents. Even if no such meetings take place, documents such as consents to act as a director are still required to be prepared by the professional service provider, forwarded to the client for signing and then returned to the professional service provider. Two further disadvantages of the prior art are that communications and meetings between the client and the service provider may usually only be done during business hours, and that it exposes the person(s) to the risk of human error.

From a professional services provider's perspective, the above factors may translate into the need for the expenditure of a certain amount of time and labour, with their associated costs, which in turn can translate into a certain minimum price which must be charged to the client in order for the work to be profitable. They also mean that the professional services provider's knowledge may only be given for the benefit of one client at a time rather than being provided simultaneously to a number of clients (and thus ‘leveraged’), and may only be given during office hours rather than 24 hours a day, 7 days a week.

On the other hand, in relation to option 3, the person(s) may have significant problems in creating their corporate entity because of a lack of understanding, skill, knowledge, or appropriate guidance or because they are required to fill in or create (or both) an extensive or confusing (or both) array of forms and documentation which may be very time consuming. Also, they may not obtain the most appropriate corporate entity for their needs as they may not be aware of certain legal ramifications of the types of companies that they may choose to create, and there is generally a high chance of making mistakes.

The applicant does not concede that the prior art discussed in this specification forms part of the common general knowledge in the art at the priority date of this application.

### SUMMARY OF THE INVENTION

It is an object of the invention to provide a method and system for assisting in the formation of a corporate entity which may ameliorate at least some of the disadvantages outlined above.

In accordance with a first aspect of the present invention, there is provided a method for assisting in the formation of a corporate entity, in at least one answering session, by providing a processor means in interactive communication with a user attempting to form said corporate entity, said processor means being configured to perform automatically the following steps: (a) communicating at least one set of one or more questions to said user via an interactive communications device and enabling said user to provide, for storage, one or more answers to said communicated questions; (b) selecting a further set of one or more questions for communication to said user, wherein the selection of at least one question in said selected further set of one or more questions is dependent upon said user's answer to one or more previous questions; (c) communicating said further set of one or more questions to said user and enabling said user to provide, for storage, one or more answers to said further set of communicated questions; (d) repeating at least some of the above steps until said user has provided at least enough information to allow said processor means to determine the documents that are legally required for the formation of said corporate entity, wherein at least one repetition includes a repetition of steps (b) and (c); (e) determining the documents that are legally required for the formation of said corporate entity; and (f) generating said legally required documents referred to in step (e) in an electronic form.

The method can also include the step of storing said user's one or more answers to said questions in a database structure associated with said processor means. Preferably one or more document templates are accessible by said processor means, and step (f) includes the sub steps of: selecting at least one document template corresponding to at least one of said documents determined in step (e); and populating said at least one selected document template with one or more of said user's stored answers. In an embodiment at least one of said user's stored answers is mapped to at least one corresponding text insertion area contained in said at least one selected document template to populate said at least one selected document template.

Preferably at least once during the performance of the method the selection of at least one of said questions in said selected further set of one or more questions made in step (b) is dependent upon said user's answer to at least two previous questions. In one embodiment of the invention, in step (d) a final repetition ends in a repetition of step (a).

In a preferred embodiment of the method the documents legally required for the formation of the corporate entity can also include the documents required to be in existence shortly after the incorporation of the corporate entity.

Preferably, the method can also include the steps of generating execution and/or lodgement and/or retention instructions for the generated documents, delivering the legally required documents to a user in an electronic form, storing the answers to the series of questions in a database and utilising the stored information to generate the legally required documents.

The method also preferably includes the step of providing to the user legally-based and practice-based information relating to the questions displayed to the user, in order to assist the user to answer the questions correctly and appropriately. The questions may also preferably be displayed with hyper links to further legally-based and practice-based information.

In one embodiment the user answers the questions from a client computer on a network and the questions displayed to the user are preferably dynamically updated depending upon changes in the relevant law and practice. Preferably, the user is able to review their answers (or a subset or a selection of them) to the set of one or more questions as they proceed through the successive set of one or more questions. Preferably, the user is able to amend their answers to any one of the set of one or more questions as they proceed through the successive set of one or more questions.

Preferably, the user is presented with a summary of the answers (or a subset of them) once the user has provided enough information to create the desired corporate entity. When the user provides an answer to a question which must by its nature be incorrect, an error message can be presented to the user.

The user can be allocated a unique identifier to identify the user and/or answering session, such as a username and associated password. Preferably, the user can be provided with the ability to use at least one or more of the answers from a previously recorded answering session and use the answers in a new answering session without having to re-answer the questions from scratch.

At least one of said sets of one or more questions preferably includes only one question. Preferably the processor means communicates all of the questions of a set of questions having more than one question to the user substantially simultaneously.

In accordance with a further aspect of the present invention, there is provided a computer memory storing thereon an application program for controlling the operation of a processor means to assist in the formation of a corporate entity in at least one answering session, said application program controlling said processor means to: (a) communicate at least one set of one or more questions to said user and enable said user to provide, for storage, one or more answers to said communicated questions; (b) select a further set of one or more questions for communication to said user, wherein the selection of at least one question in said selected further set of one or more questions is dependent upon said user's answer to one or more previous questions; (c) communicate said further set of one or more questions to said user and enable said user to provide, for storage, one or more answers to said further set of communicated questions; (d) repeat at least some of the above steps until said user has provided at least enough information to allow said processor means to determine the documents that are legally required for the formation of said corporate entity, wherein at least one repetition includes a repetition of steps (b) and (c);(e) determine the documents that are legally required for the formation of said corporate entity; and (f) generate the legally required documents referred to in step (e) in an electronic form.

Preferably, the application program controls the processor to provide to the user, legally-based and practice-based information relating to the questions as the questions are displayed to the user. The questions displayed to the user are preferably dynamically updated depending upon changes in the relevant law or practice. The user can be able to review their answers to the set of one or more questions as they proceed through the successive sets of one or more questions. The user is able to amend their answers to the sets of one or more questions as they proceed through the successive sets of one or more questions. The application program can control the processor so that upon amendment by the user of a previously answered set of one or more questions, the successively answered questions are preferably deleted/amended depending upon the user's amended answer. The user can be presented with a summary of the answers once the user has provided enough information to create the desired corporate entity. When the user provides an answer to a question which must by its nature be incorrect, an error message can be presented to the user.

Ideally, the user can be allocated a unique identifier to identify the answering session. Preferably, the user is able to copy at least one or more of the answers from a previously recorded answering session and use the answers in a new answering session. An electronic file can be created by interrogating the database structure and thereby generating an electronic file for filing with a registration authority that registers corporate entities.

In accordance with a further aspect of the present invention, there is provided a system for assisting in the formation of a corporate entity in at least one answering session, said system including: processor means in interactive communication with a user attempting to form said corporate entity; interactive communication means, in communication with said processor means, adapted to allow said processor means to communicate sets of one or more questions to said user and to allow said processor means to receive said user's answers to said communicated questions, data storage means associated with said processor means configured to store said user's received answers; said processor means running an application program configured to cause said processor means to communicate at least one set of one or more questions to said user and to receive answers thereto from said user; to successively select and communicate a further set of one or more questions to said user and to receive answers thereto from said user; and to repeat said selection and communication of further sets of one or more questions until said processor means has received at least enough answers from said user to allow said processor means to determine the documents that are legally required for the formation of said corporate entity, wherein the selection of at least some of said further sets of one or more questions by said processor means is based on said user's answer to one or more previous questions; said application program further causing said processor means to determine the documents that are legally required for the formation of said corporate entity; and to generate said legally required documents in an electronic form using at least some of said user's stored answers.

Preferably said data storage means includes a database structure associated with said processor means, said database structure having a plurality of user answer fields in which at least selected ones of said user's answers are stored. Said database structure can additionally include a question database from which said communicated questions are selected by said processor means.

Preferably one or more document templates are accessible by said processor means, and said application program causes said processor means to merge at least one selected document template corresponding to said legally required documents, with at least a subset of said user's stored answers to generate said legally required documents. In an embodiment the application program causes said processor means to map said user answer fields, to corresponding text insertion areas contained in said at least one selected document template. Preferably at least one of said user answer fields are mapped to a plurality of corresponding text insertion areas in said at least one selected document template.

The application program preferably causes said processor means to select at least one of said further sets of one or more questions on the basis of said user's answers to at least two previous questions.

In a preferred embodiment the final set of one or more questions selected by said processor means can include one or more predetermined questions.

Preferably the application program causes the processor means to communicate all of the questions of a set of questions having more than one question to the user substantially simultaneously.

In the description and claims of this specification the word “comprise” and variations of that word, such as “comprises” and “comprising” are not intended to exclude other features, additives, components, integers or steps but rather, unless otherwise stated explicitly, the scope of these words should be construed broadly such that they have an inclusive meaning rather than an exclusive one.

In the description and claims of this specification the phrase ‘documents to form said corporate entity’ and variations of that phrase, such as ‘documents to form a corporate entity’, ‘required documents’ and ‘necessary documents’ are not intended to be restricted to the bare minimum of document(s) required to form a corporate entity by lodging them with a corporate entity registration authority, but are also intended to extend to documents which the law requires be created and maintained by the corporate entity or its officers, or persons associated with it, at the time of its incorporation or within a reasonable time thereafter (e.g. within 3 months).

The preferred embodiment also allows for the creation of many different types of companies. In the case of Australia, the preferred embodiment allows for the creation of both private and public companies, including companies limited by shares, companies unlimited with a share capital, companies limited by guarantee and no liability companies, thereby providing an array of different corporate entity creation options.

In the description and claims of this specification the phrase ‘practice-based information’ and variations of that phrase, such as ‘practical information’ and ‘practice’ relate to various practices which may exist from time to time in relation to the creation of corporate entities which, although not being directly referable to or founded upon any particular law(s), are generally accepted as being appropriate and valid by professional services providers who engage in the business of creating corporate entities, or are generally accepted by or imposed by corporate entity registration authorities.

In the description and claims of this specification the phrase ‘creating a corporate entity’ and variations of that phrase, such as ‘create said corporate entity’ and ‘creation of a corporate entity’ are intended not only to relate to the strict creation of a corporate entity but also relate to the satisfaction of pre-conditions for the creation of a corporate entity and to the facilitation of and assistance with the creation of a corporate entity.

### BRIEF DESCRIPTION OF THE DRAWINGS

Notwithstanding any other embodiments which may fall within the scope of the present invention, preferred embodiments of the invention will now be described, by way of example only, with reference to the accompanying drawings in which:

FIG. 1 is a schematic illustration of a preferred network arrangement over which to deploy the invention;

FIG. 2 is a diagram of the server 14 shown in FIG. 1;

FIG. 3 is a display of an Internet browser web page presented to a user for selecting a particular configuration of a company type;

FIG. 4 is a display of an Internet browser web page presented to a user for providing information relating to the selection of a particular configuration of a company type;

FIG. 5 is a display of an Internet browser web page presented to a user to allow the user to input information relating to the details of a proposed company;

FIG. 6 is a display of an Internet browser web page presented to a user for selecting one of two company types.

FIG. 7 to FIG. 10 illustrate a series of flow charts instructive in the creation of a web site for the creation of documentation associated with an Australian Corporate Entity; and

FIG. 11 to FIG. 16 illustrate a series of flow charts instructive in the creation of a web site for the creation of documentation associated with a United Kingdom Corporate Entity.

### DETAILED DESCRIPTION OF THE EMBODIMENTS

A preferred embodiment provides a corporate entity creation service provider (CECSP) which functions automatically and is able to assist in the formation of a corporate entity by issuing a series of questions to a client user of a computer network, the client user replying to the series of questions in an answering session. The CECSP has a server including a processor and a memory on which an application program is stored. The application program controls the processor to generate a first set of one or more questions to the client user by transmitting data via the computer network to the client PC.

The user of the client PC responds to the first set of (one or more) questions and the answer is subsequently transmitted as data via the computer network, back to the CECSP. The application program selects a second set of questions, the selection being based upon the initial answer that the user of the client PC has provided. The second set of questions is transmitted to the client PC user. The client user continues to answer subsequent sets of questions and the CECSP continues to generate successive questions until the CECSP has enough information to create documents to form a corporate entity.

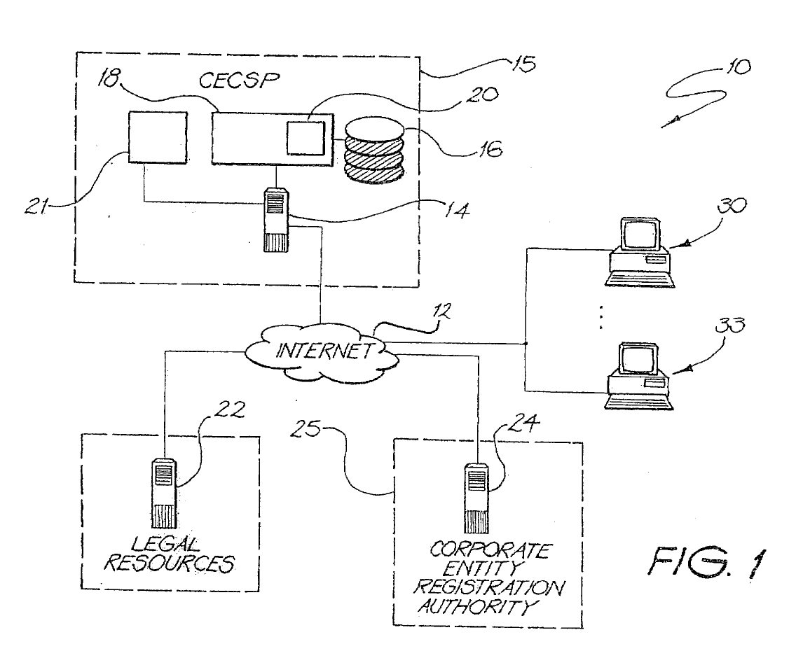

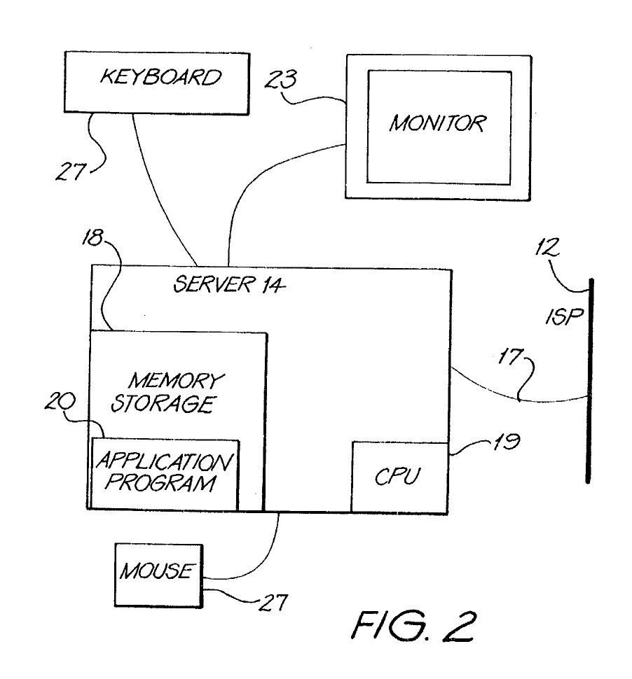

The preferred embodiment will now be described in detail with reference to FIG. 1. FIG. 1 is a schematic illustration of a system 10 for assisting in the formation of a corporate entity in an answering session. The system 10 includes a Corporate Entity Creation Service Provider (CECSP) 15. The CECSP 15 provides entity creation services to client users e.g., 30 and 33. The client users 30 and 33 exchange data with the CECSP via a communications network in the form of the Internet 12.

The CECSP 15 includes a server 14 which supports a web site 21 which is used by the client users 30 and 33 to answer questions relating to the formation of a corporate entity as will be discussed below. The CECSP 15 further includes a memory 18 on which an application program 20 is stored. The application program controls a processor (not shown in FIG. 1) to assist in the formation of a corporate entity.

The memory 18 further includes a relational database 16 which, in this embodiment, is a Microsoft™ SQL database developed by Microsoft Corporation. The server 14 can be any server such as the one in this embodiment which is a Microsoft™ Internet server IIS 4.0, the application program 20 runs on a Windows™ 2000 platform, also manufactured by Microsoft Corporation.

The CECSP 15 is also in data communication with a Legal Resources server 22 operated by a legal resource information centre for providing legal resources. The legal resources include updated legislation, reported case law and articles relating to legal issues. The web site 21 of the CECSP 15 has links to certain HTML files containing information pertinent to the formation of a corporate entity.

The CECSP 15 is also in data communication via the Internet 12 with a Corporate Entity Registration Authority's 25 server 24. The CECSP 15 is able to search the availability of proposed company names via searching the relevant names database on the Corporate Entity Registration Authority's 25 server 24. The CECSP 15 is also able to electronically transmit electronic files containing information relating to the formation of a corporate entity directly to the server 24 as will be further explained below.

Referring to FIG. 2, there is shown a block diagram of more details of the server 14 of FIG. 1. The server 14 has application program 20 stored in its memory 18. The server 14 includes a central processing unit (CPU) 19, a monitor 23 to display data to an administrator of the CECSP 15, a mouse for selecting graphical items on the monitor 23 and a keyboard 27 for inputting text data by the administrator of the CECSP. The CPU 19 is connected via a communications port to communications line 17 to connect the server 14 to an ISP (not shown) for connection to the Internet 12 and subsequently data exchange with client PCs 30 and 33.

The preferred embodiment is designed to create a corporate entity in accordance with the laws of a particular jurisdiction. The corporate entity is created through the interaction within an Internet browser type environment with a series of questions and answers being provided to a user. The particular questions required will of course be jurisdiction specific. Whilst a simplified example of a web based interaction is provided hereinafter, two particular examples of web based design are provided in the attached appendices and figures.

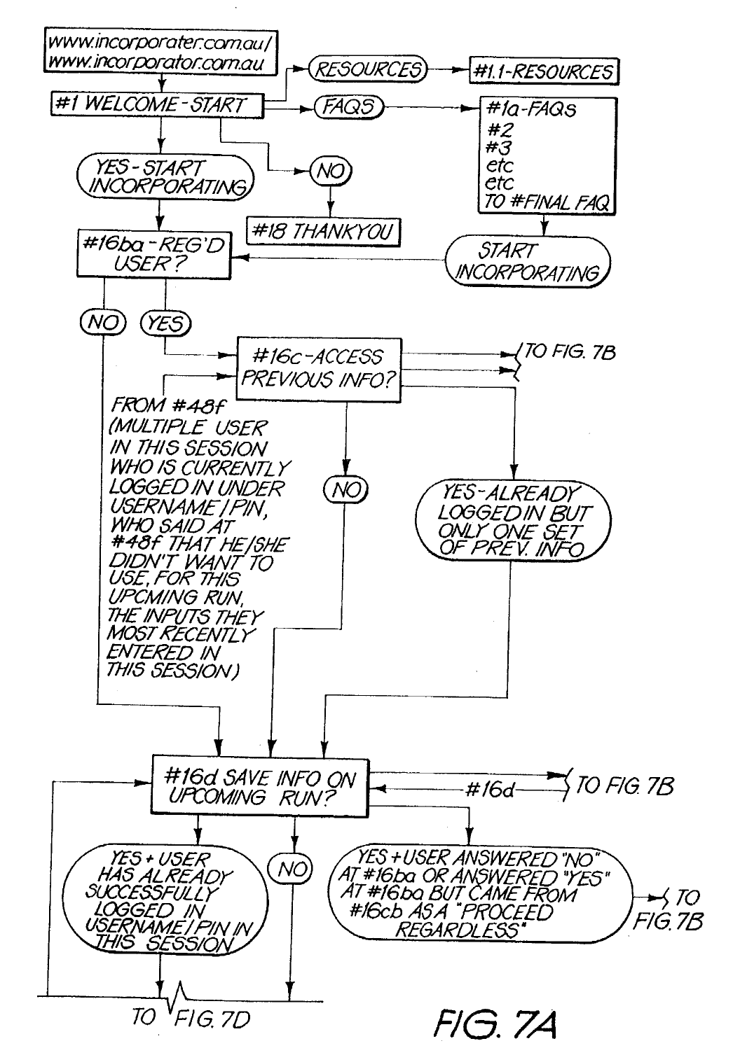

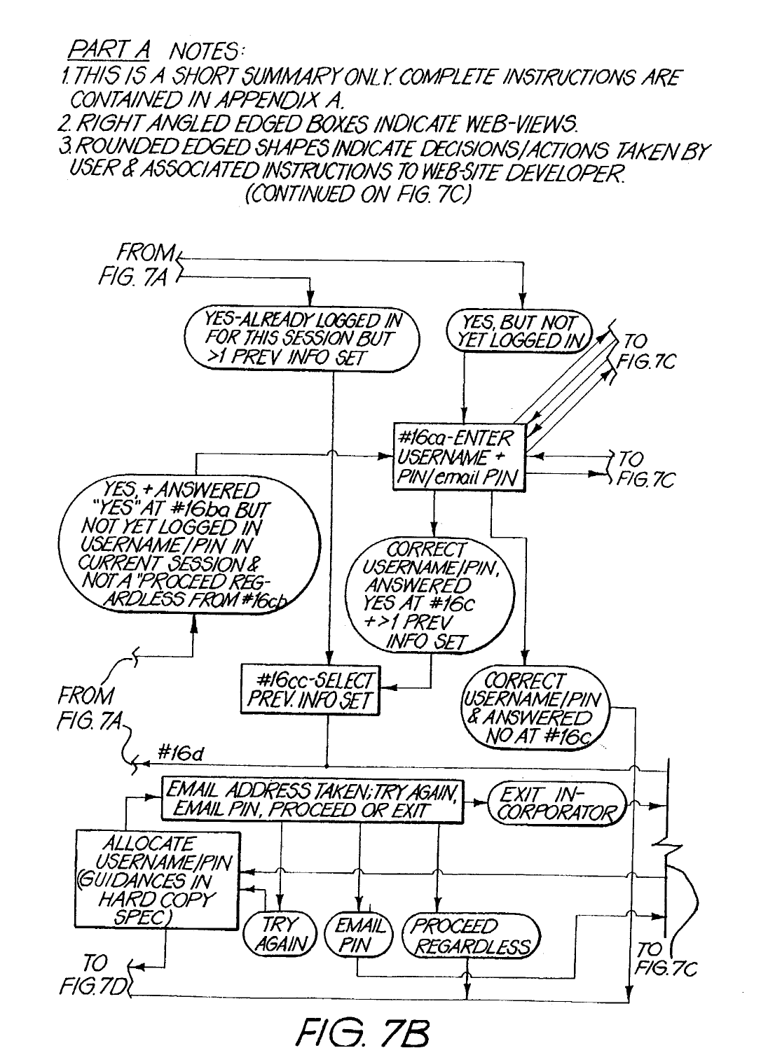

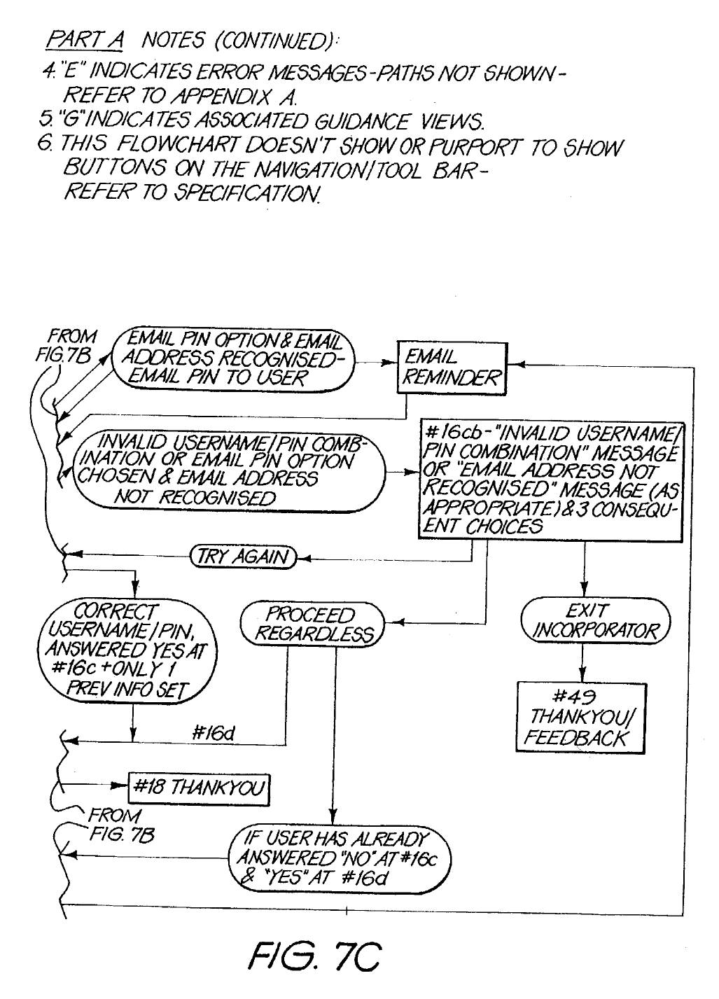

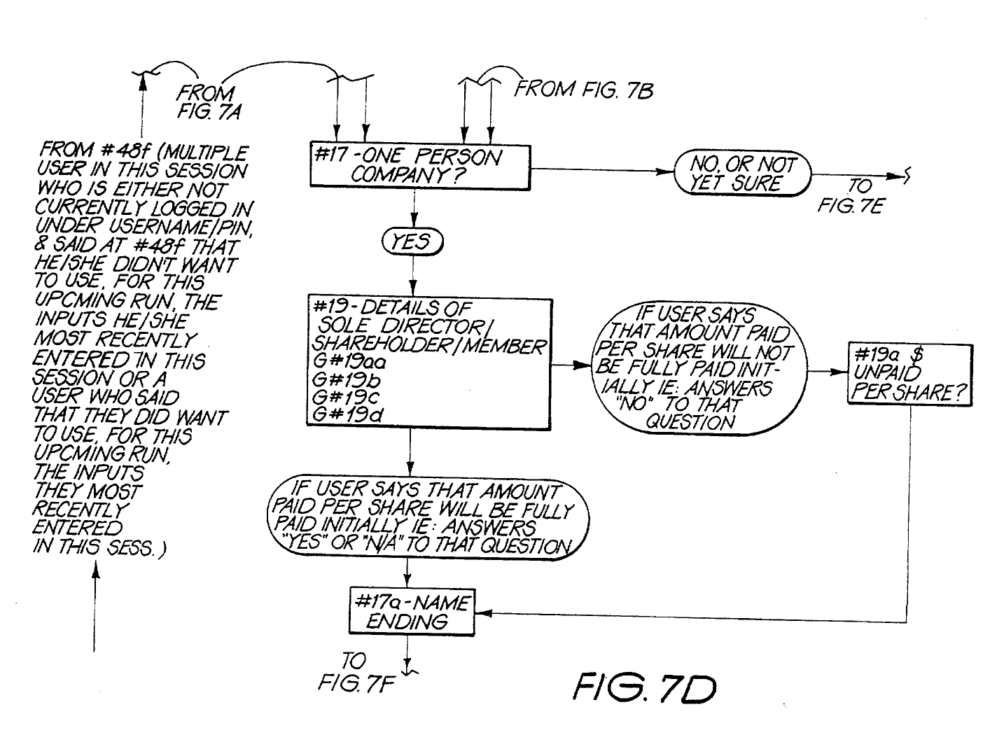

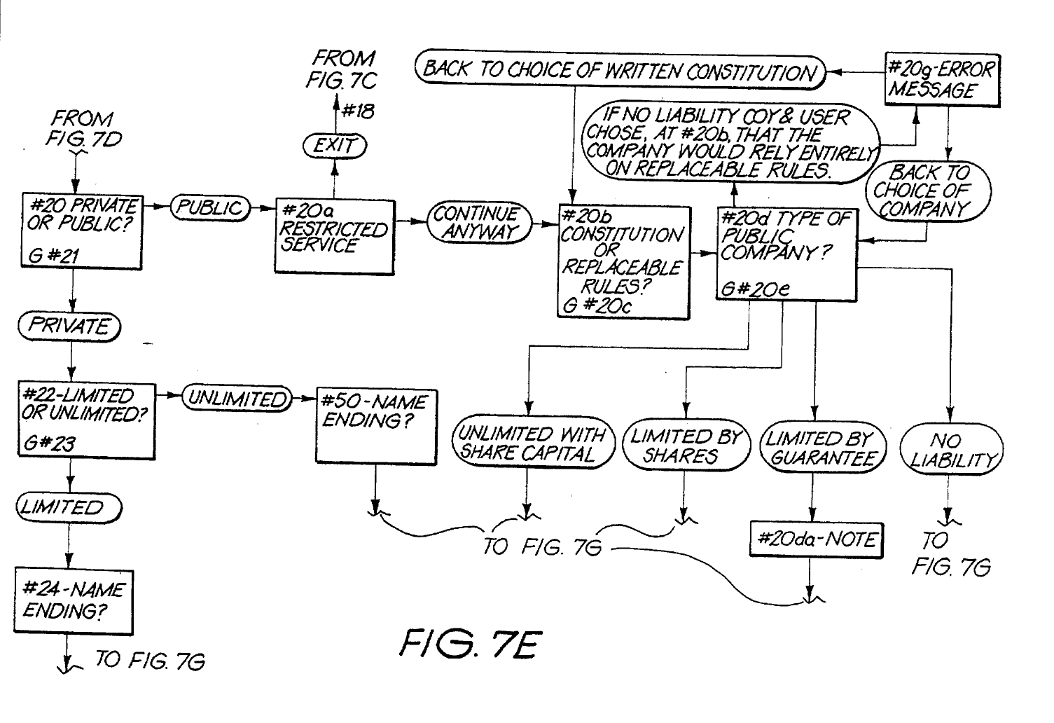

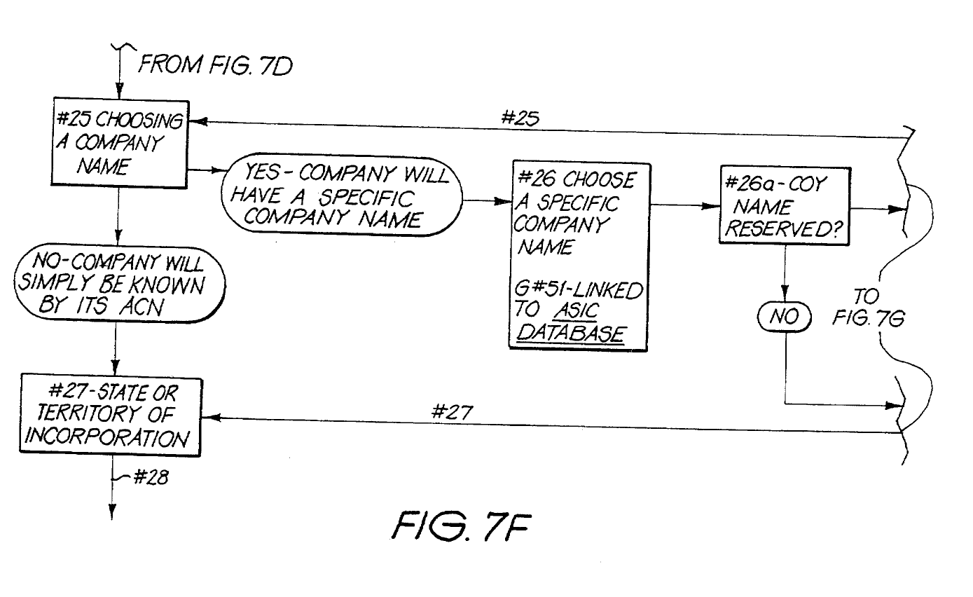

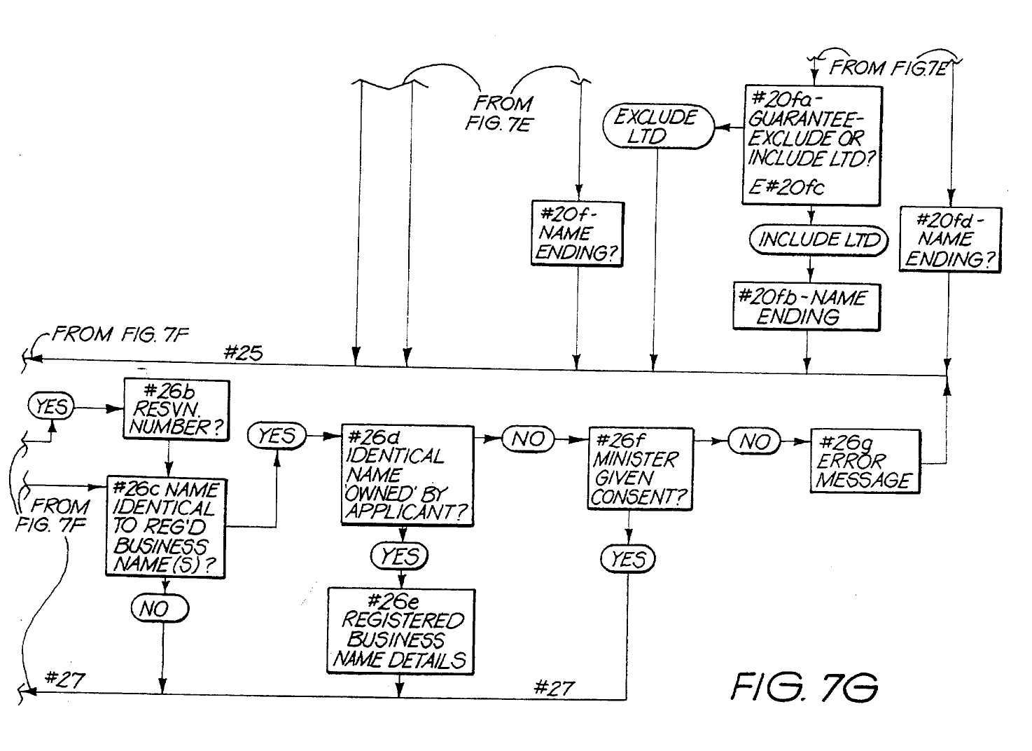

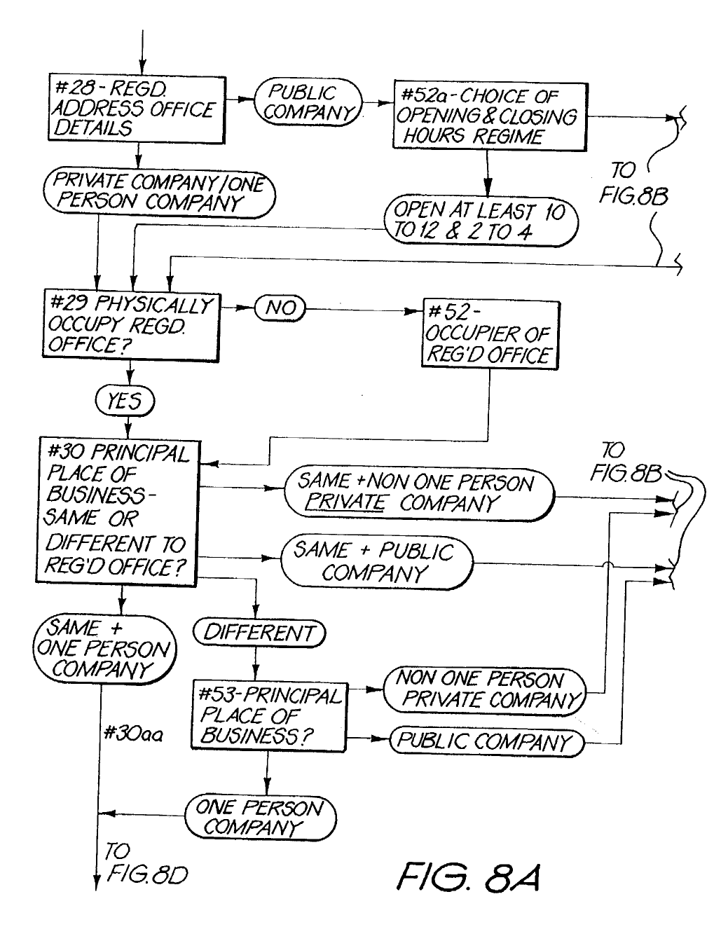

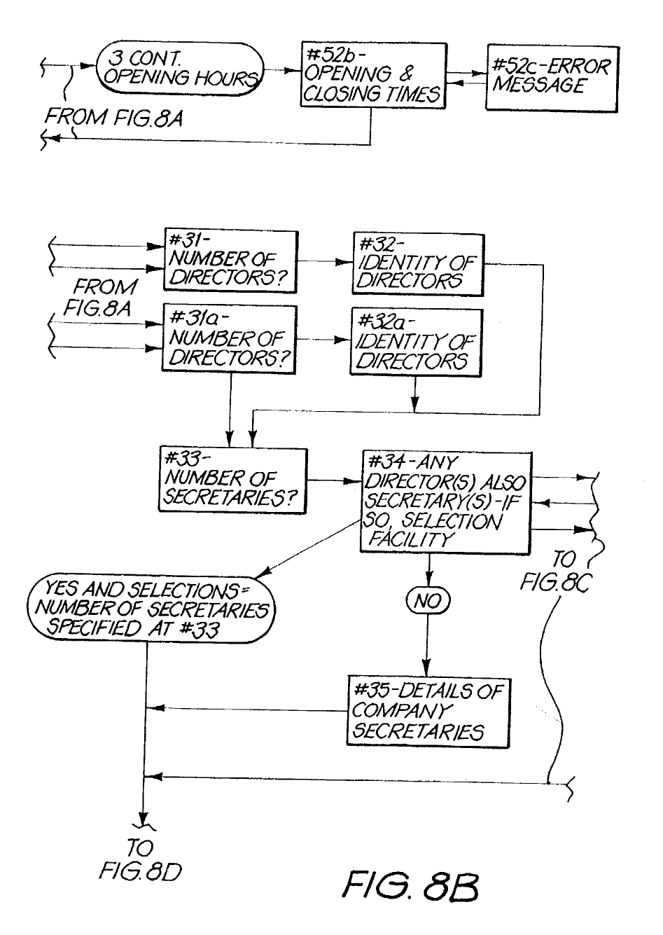

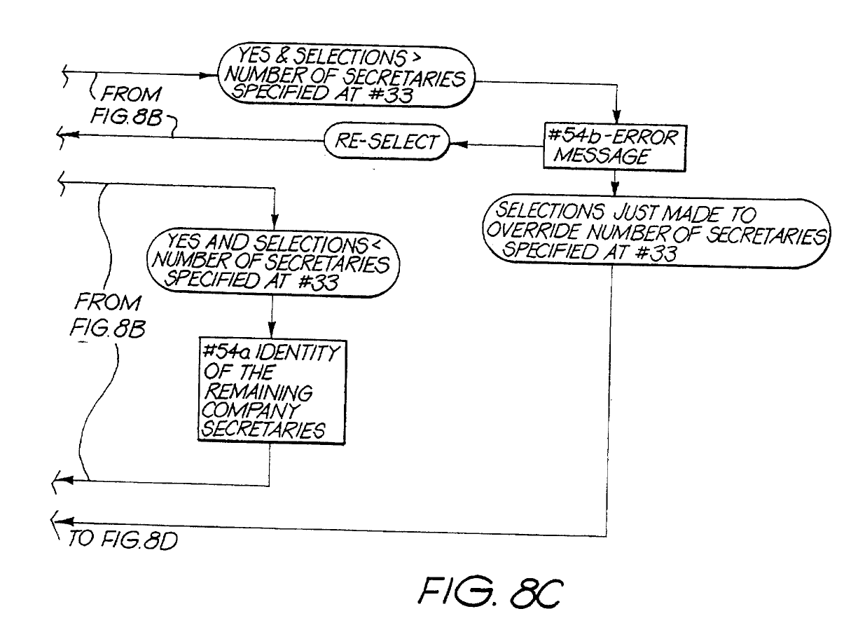

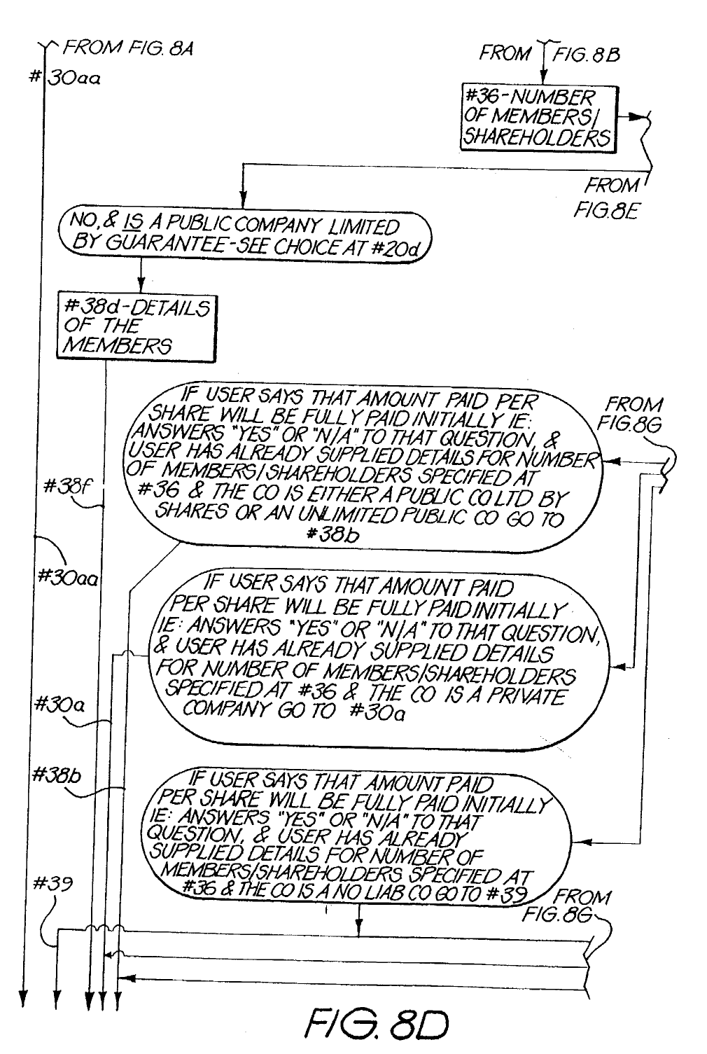

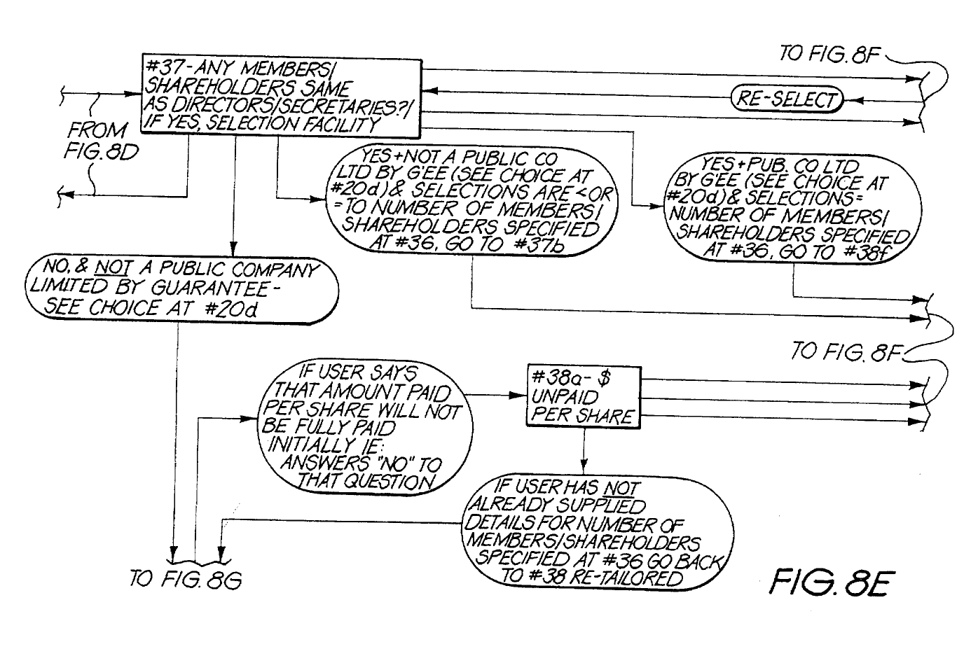

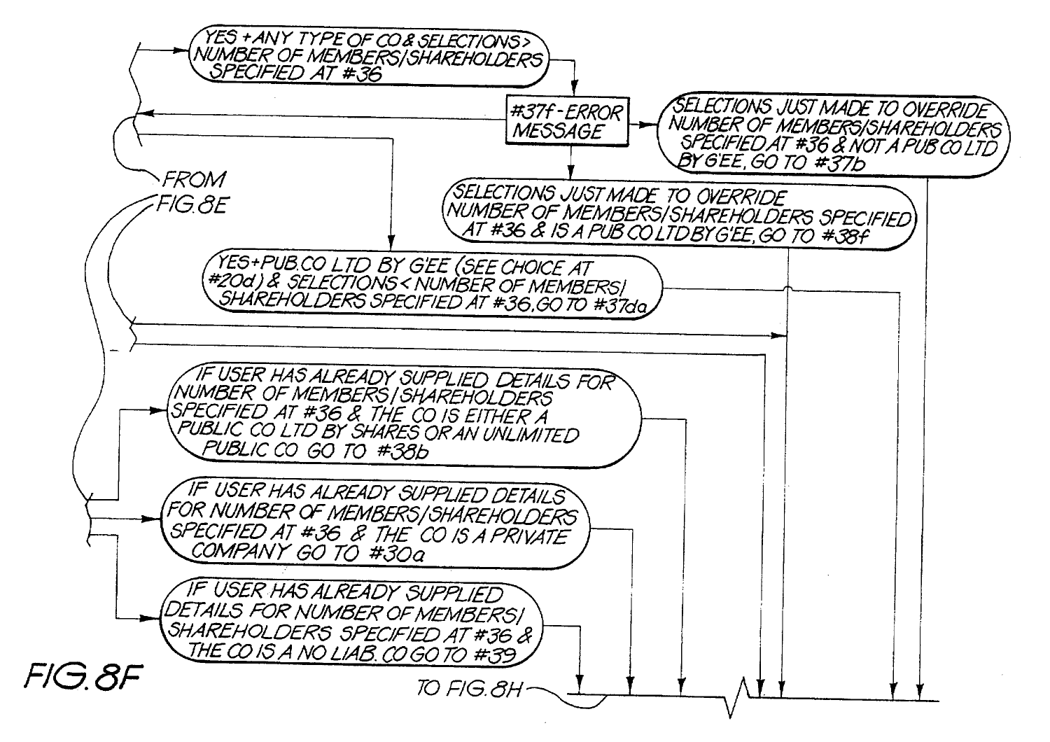

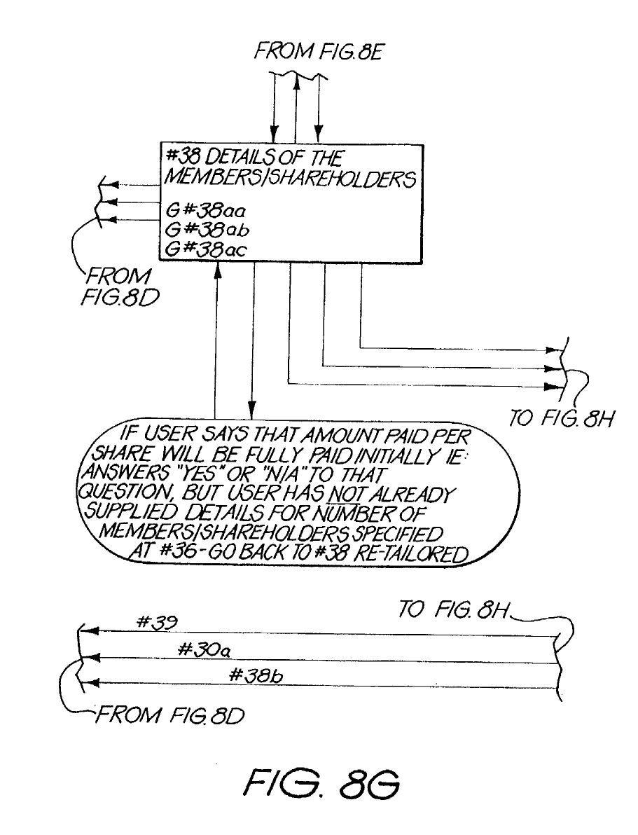

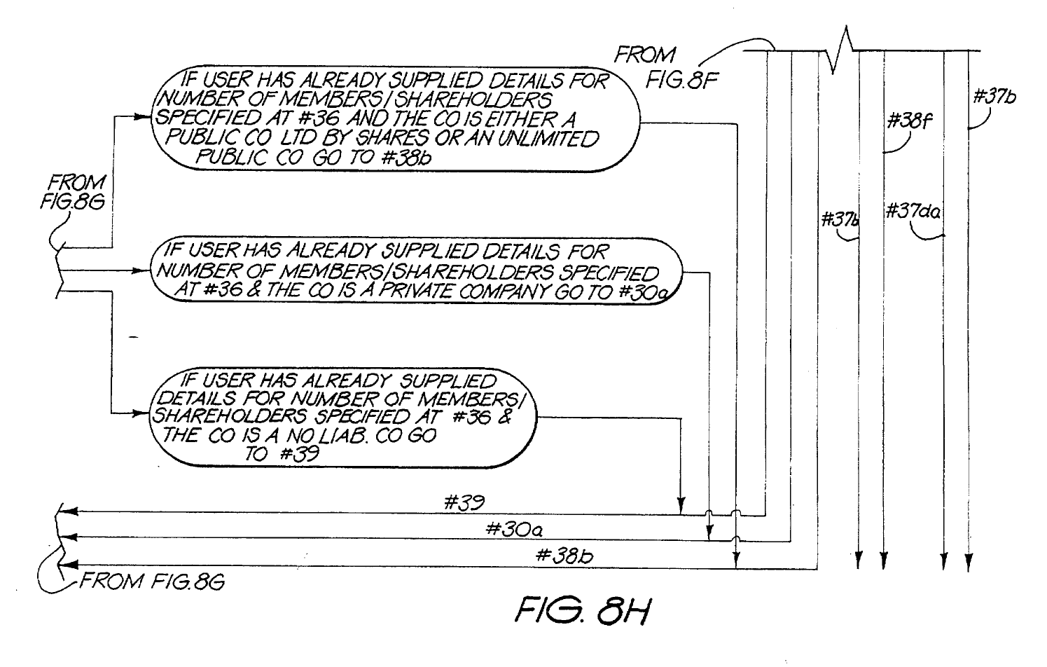

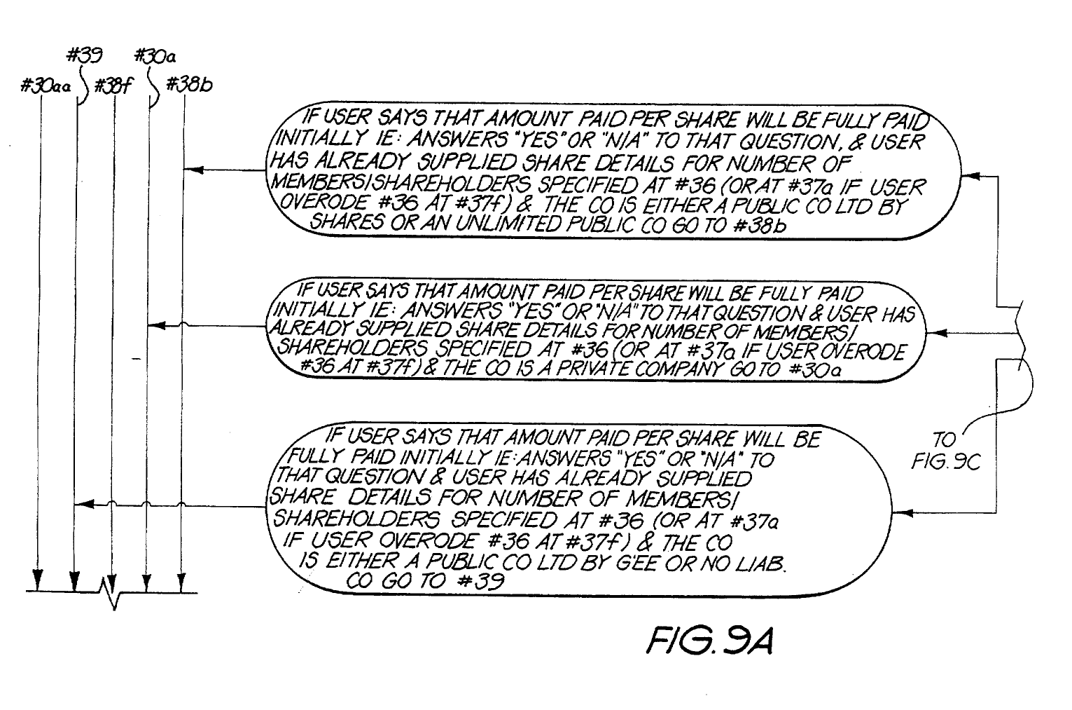

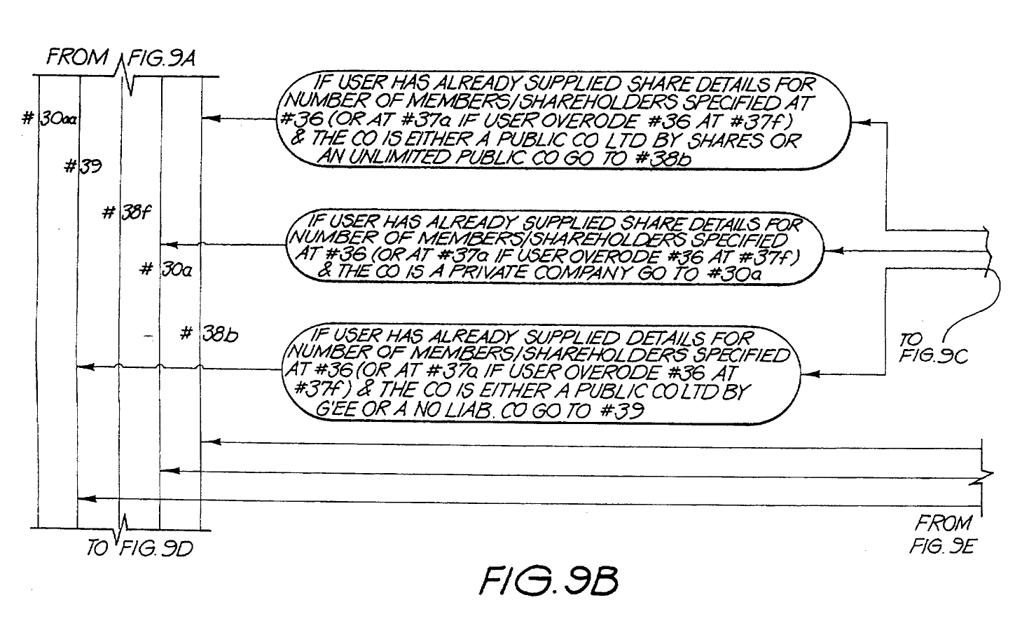

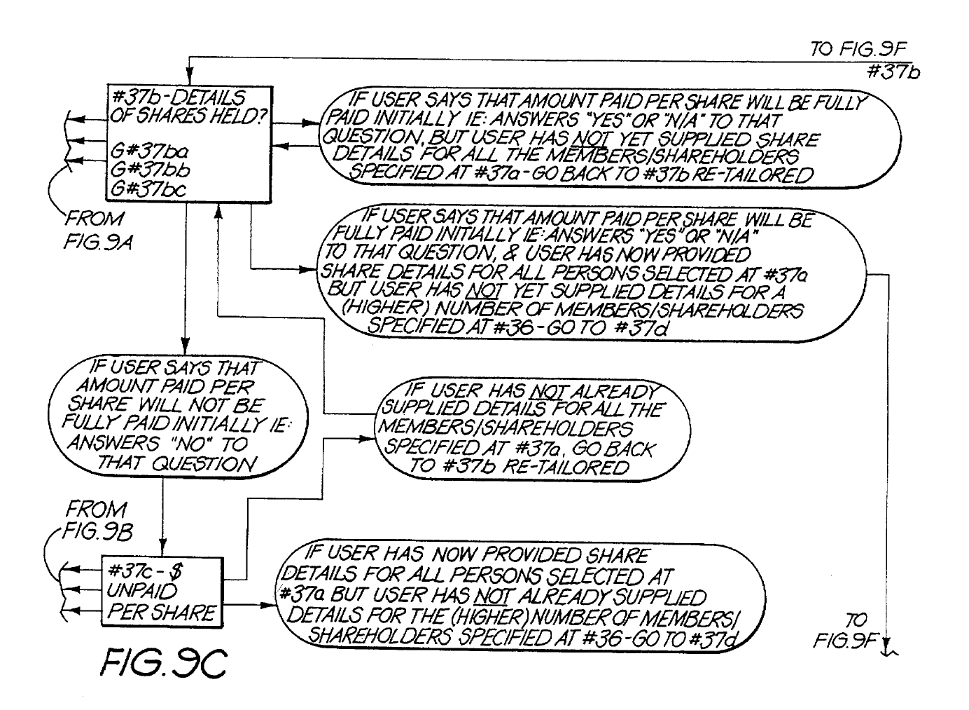

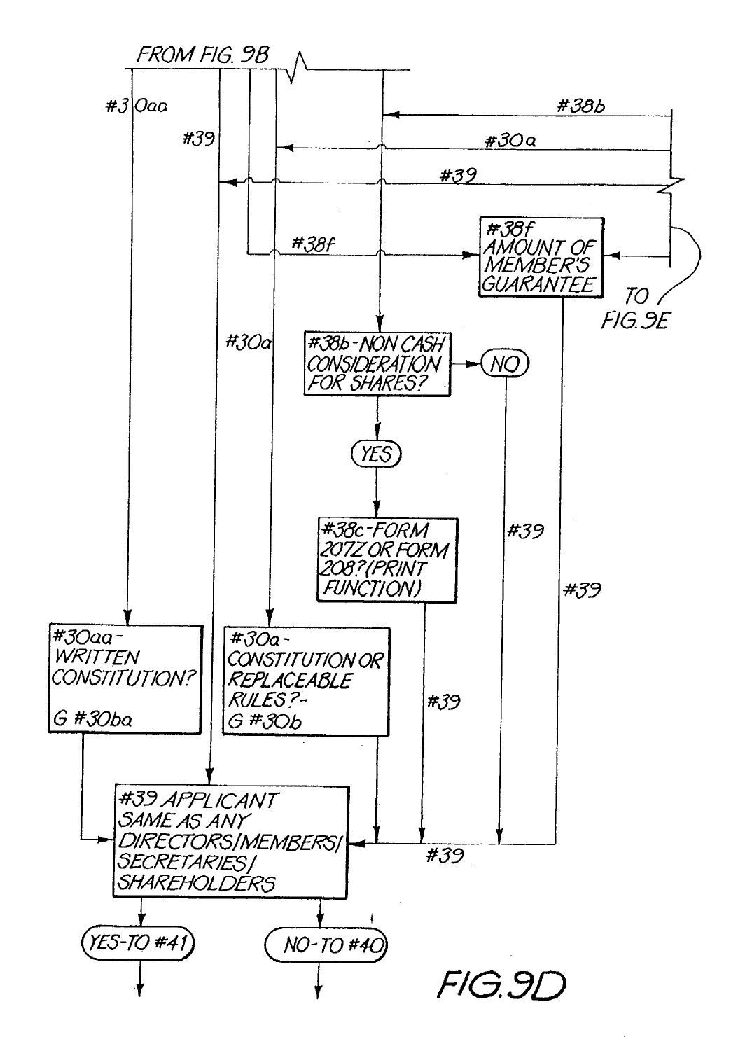

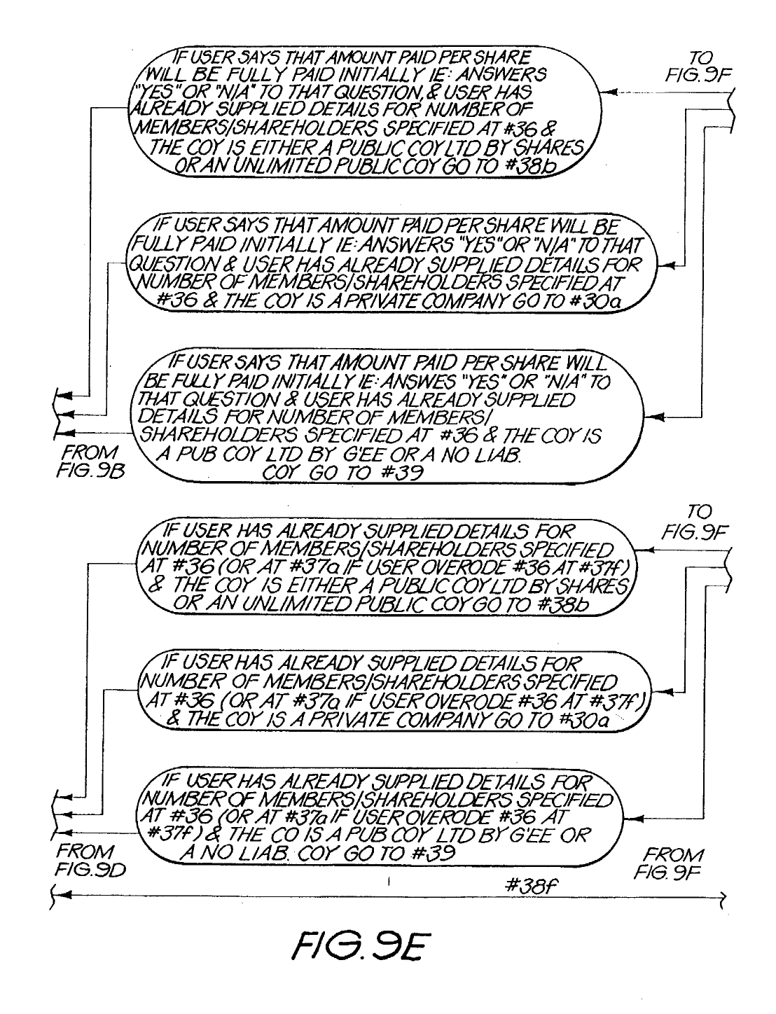

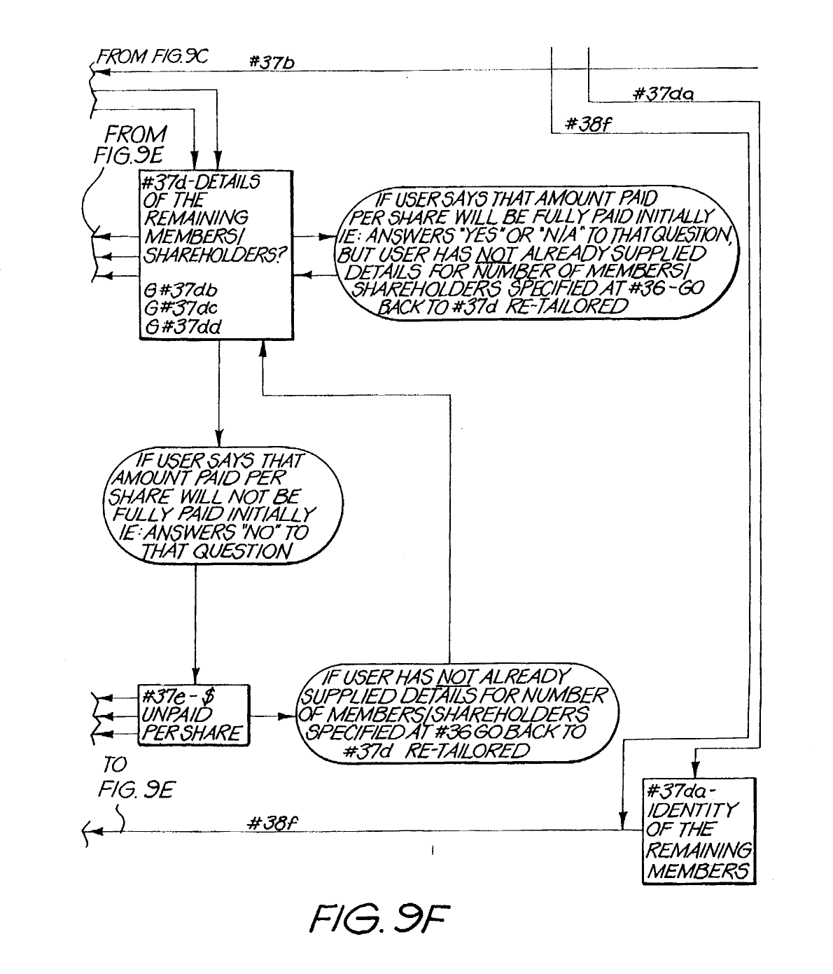

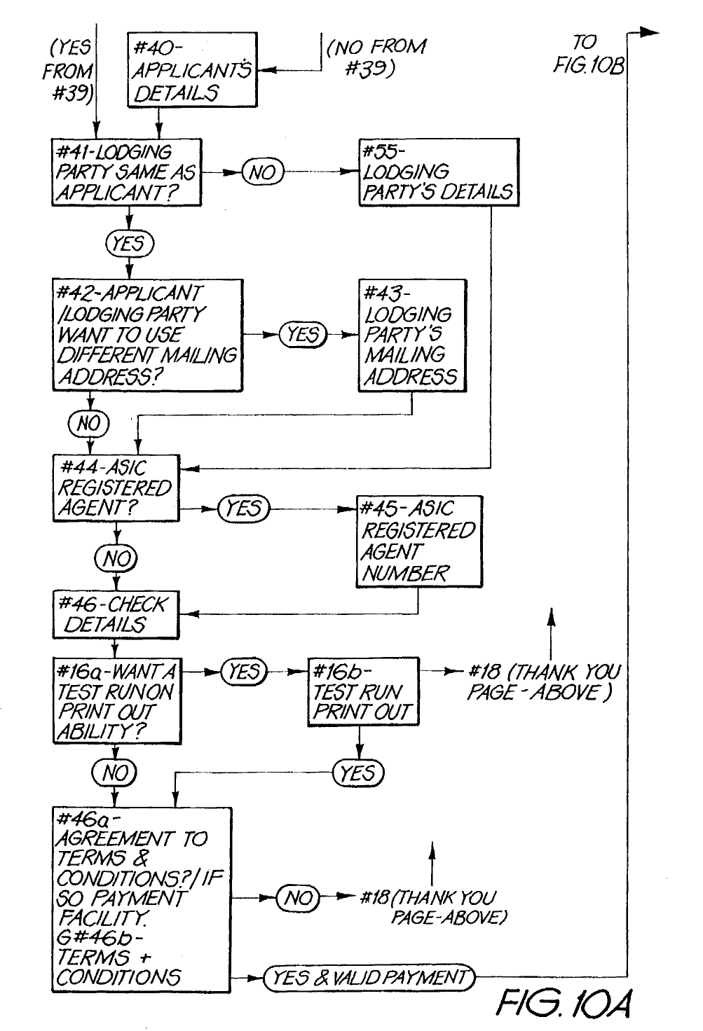

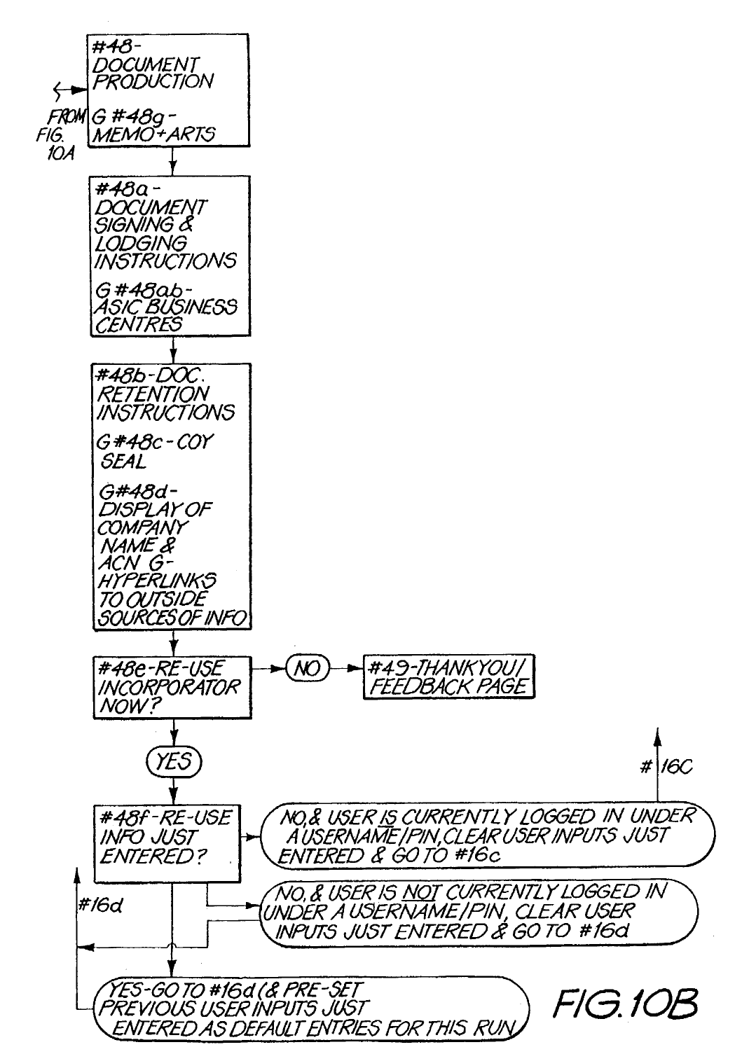

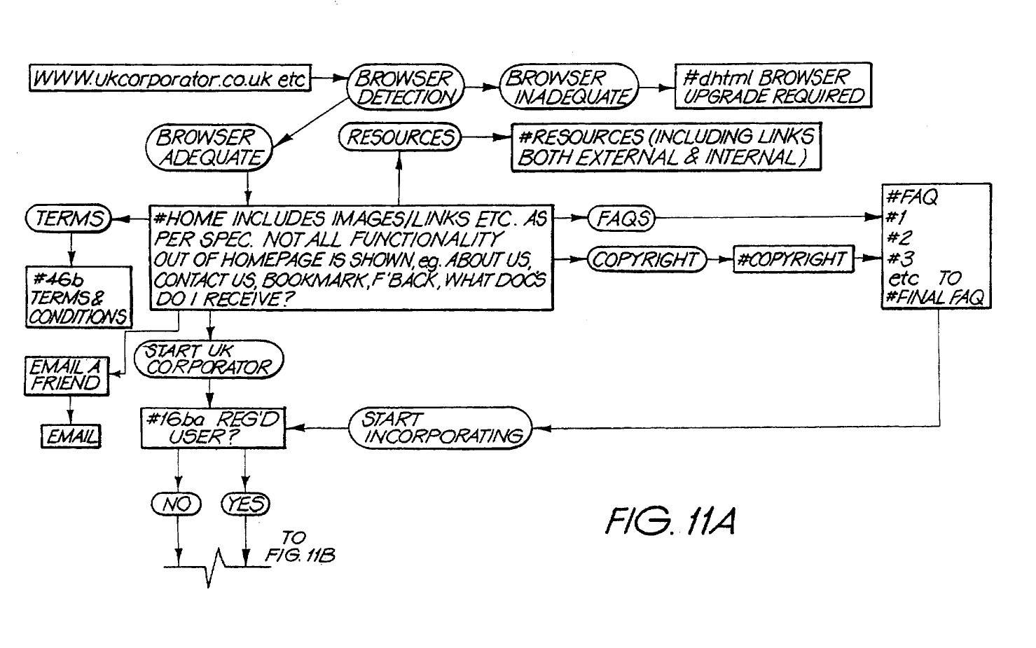

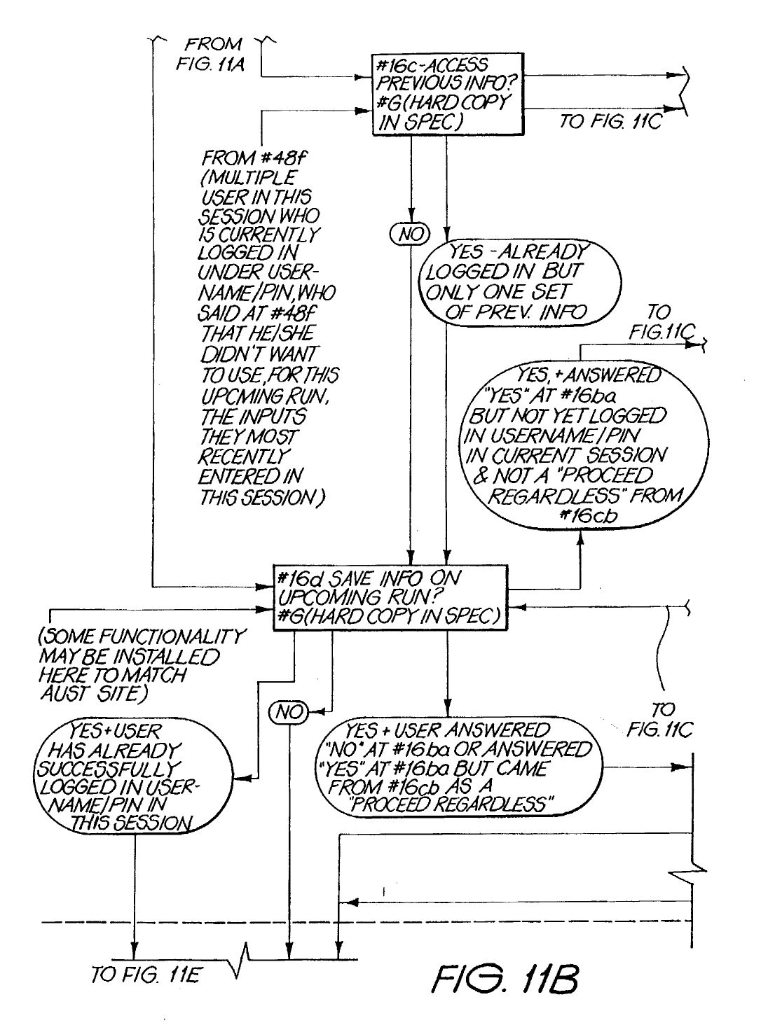

In a first example outlined in Appendix A, and FIGS. 7 to 10 of the drawings, a system is provided for creating an Australian corporate entity. Appendix A and FIGS. 7 to 10 contain instructions given to a web site developer for the creation of a web based system. In appendix A, a substantial amount of material setting out the details of the background information and explanatory material of legal concepts has been removed so as to provide a higher level of clarity. In particular, the guidance information has been substantially removed on the basis that it expounds textbooks principles that will be jurisdiction specific.

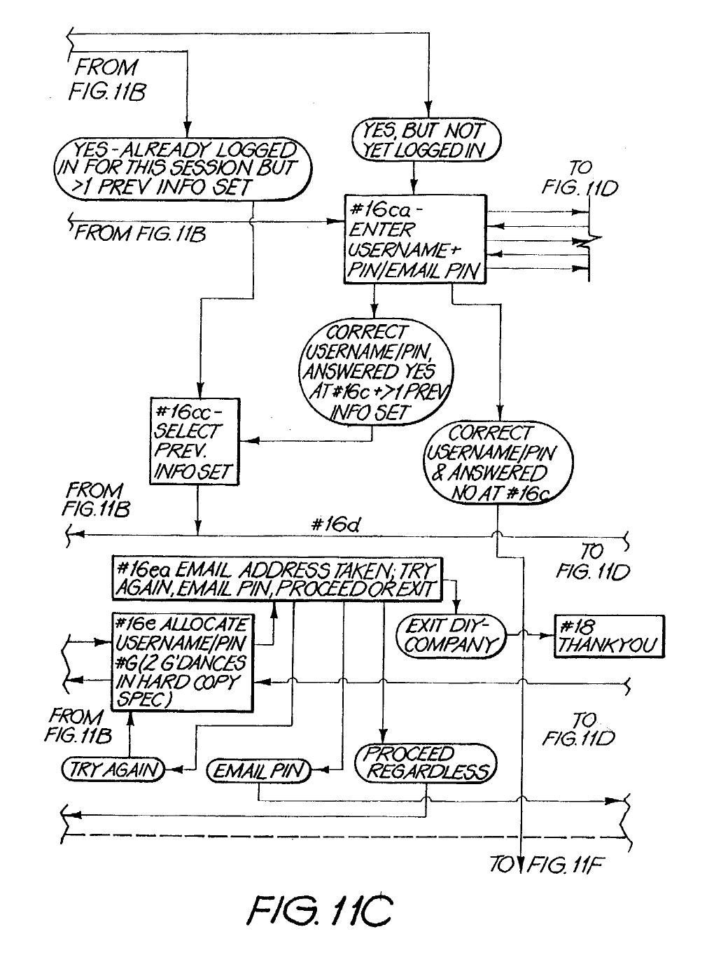

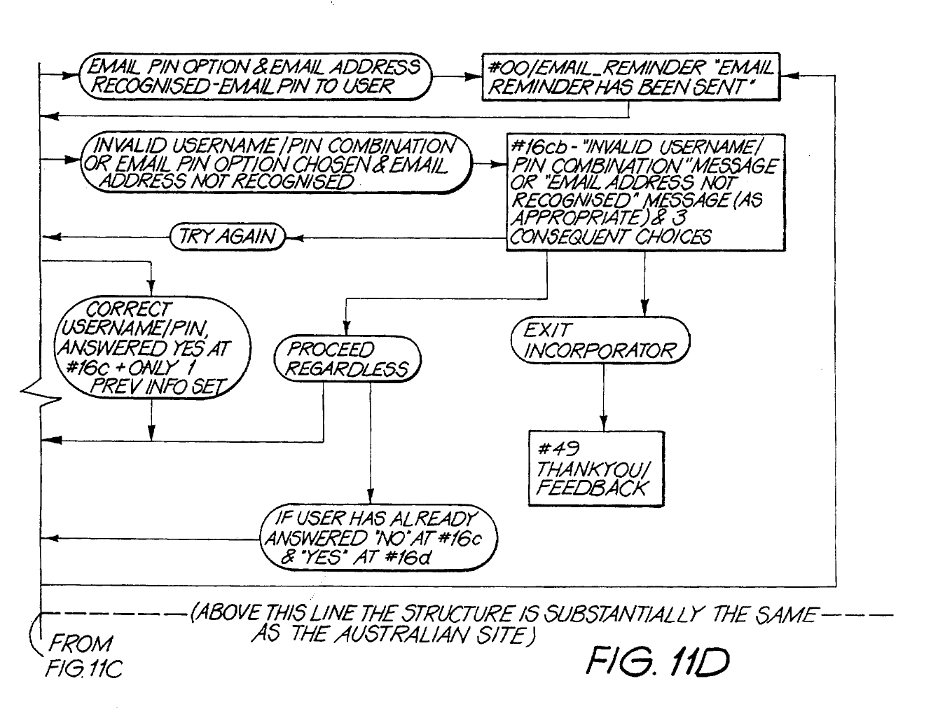

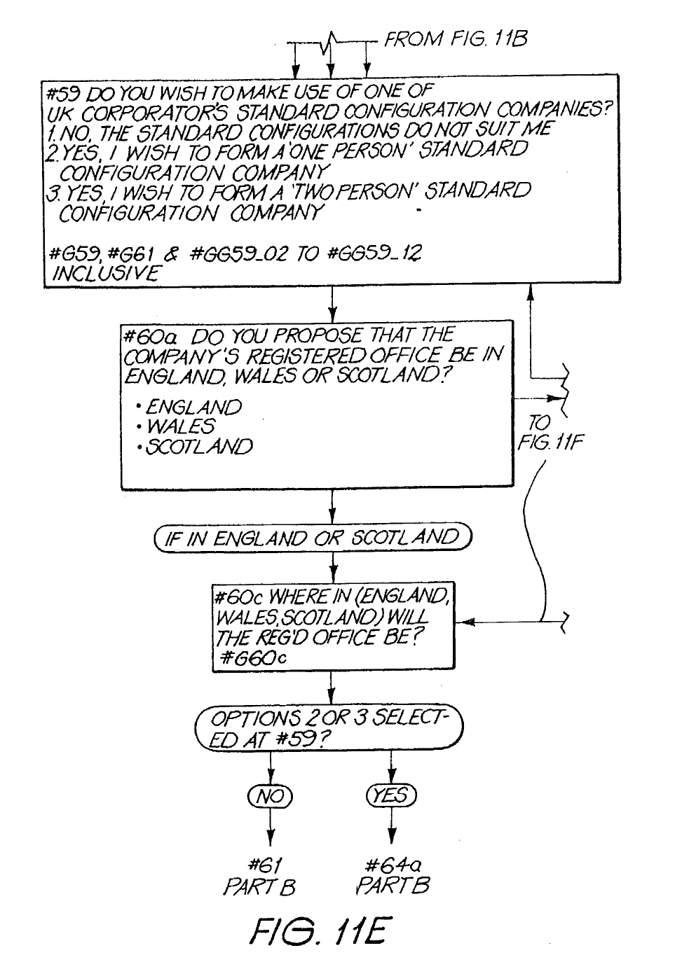

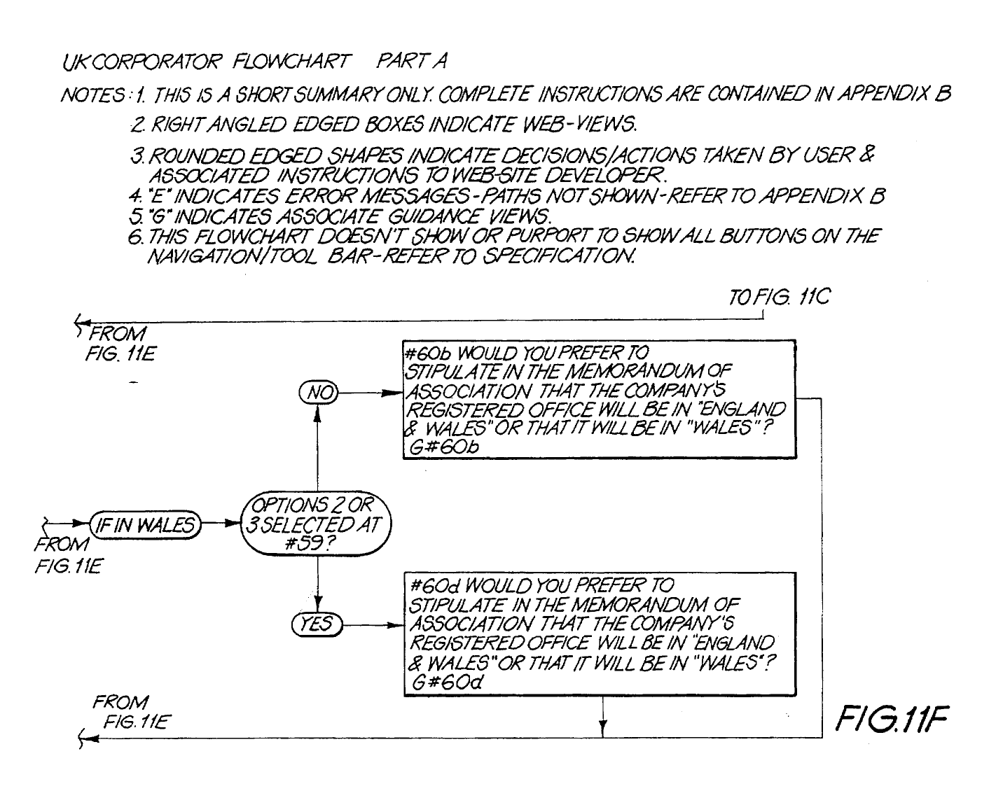

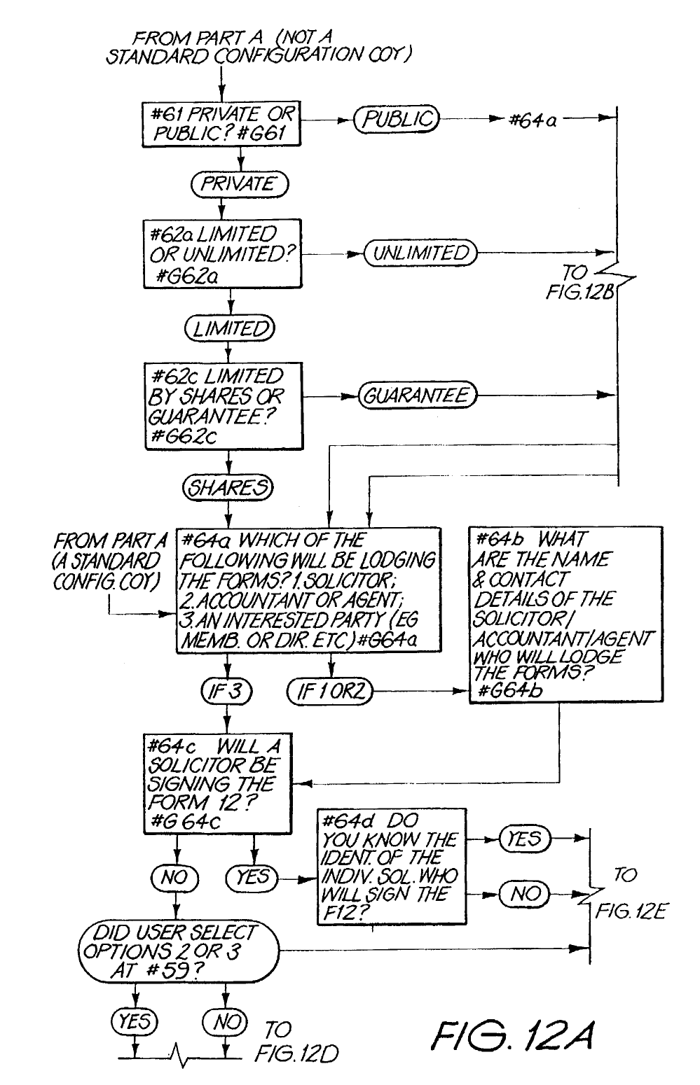

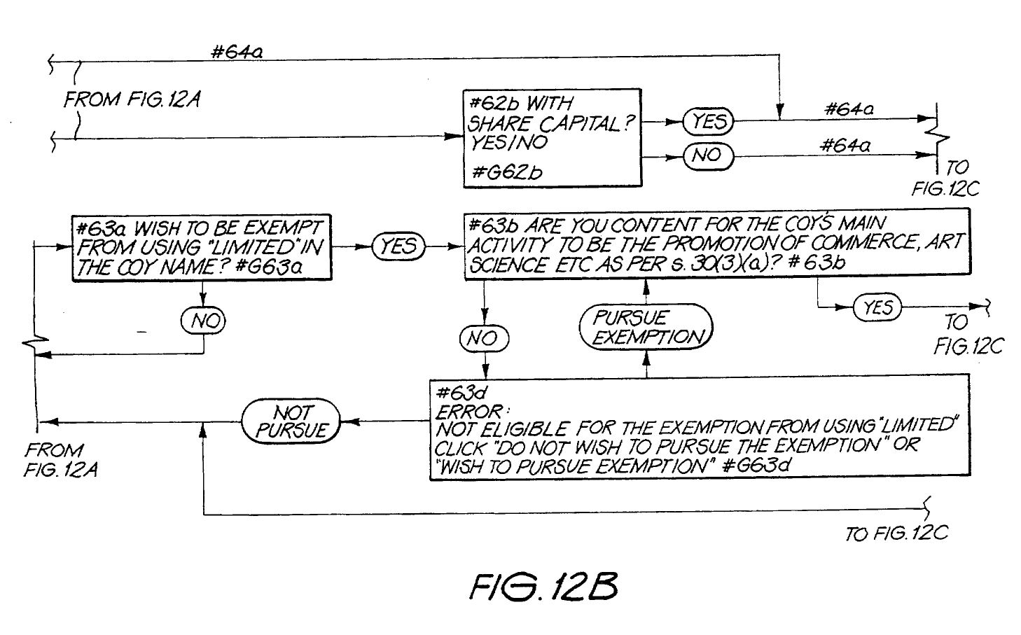

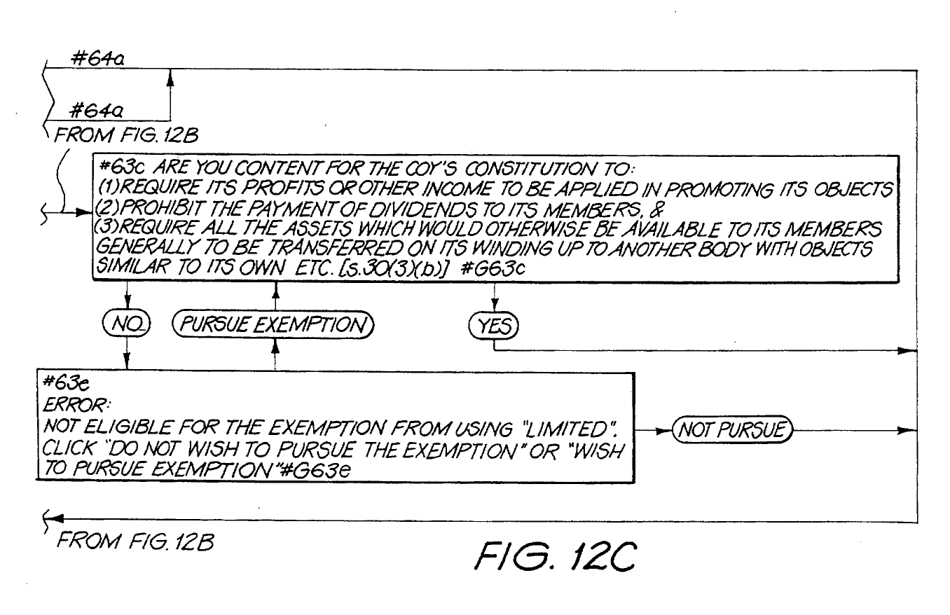

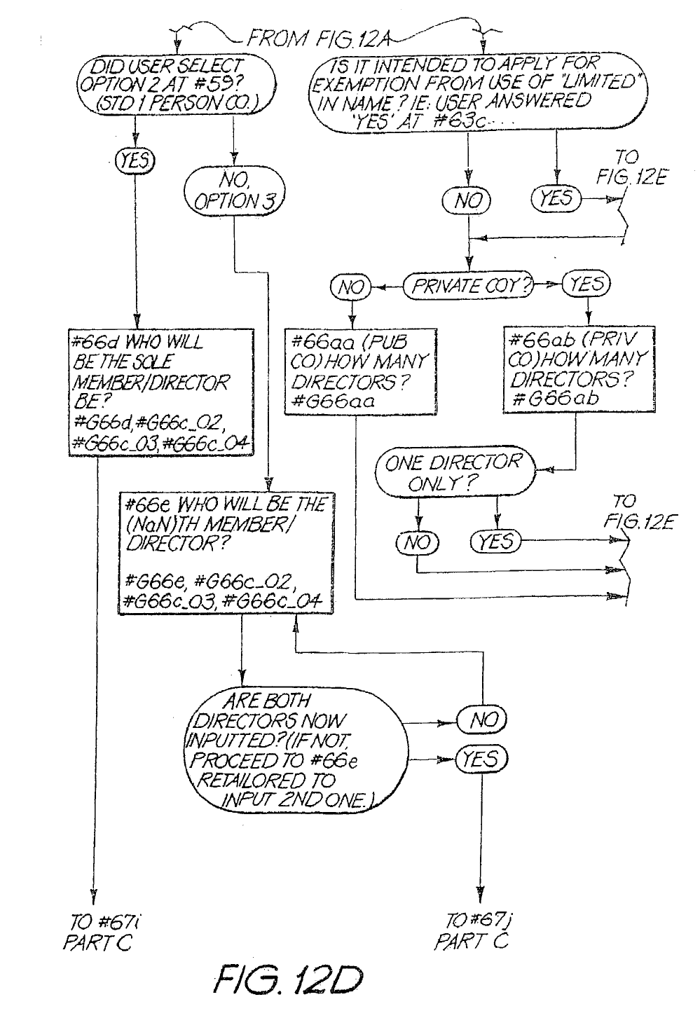

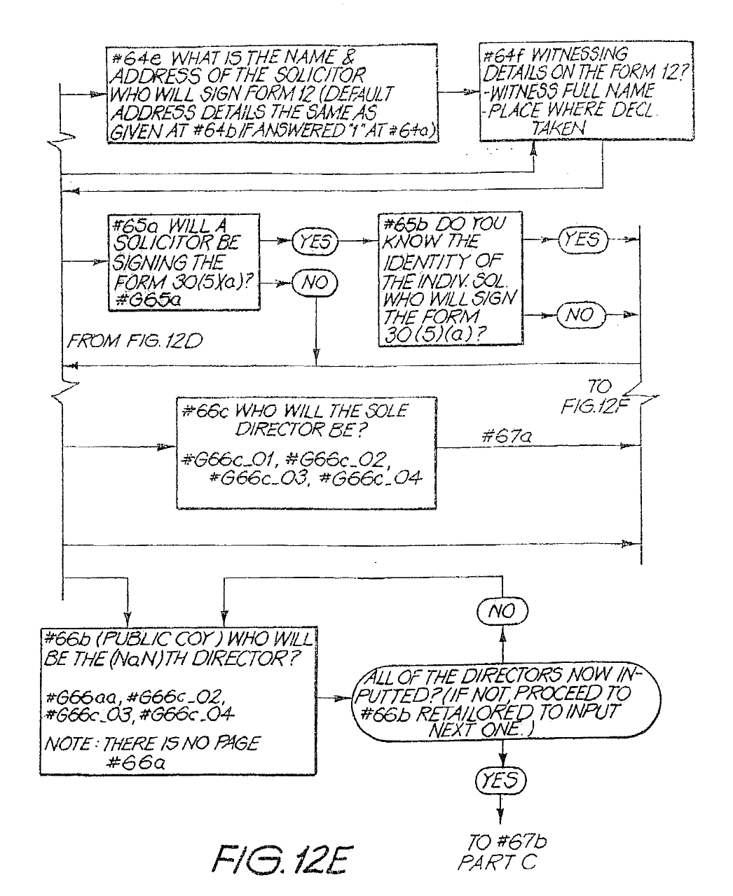

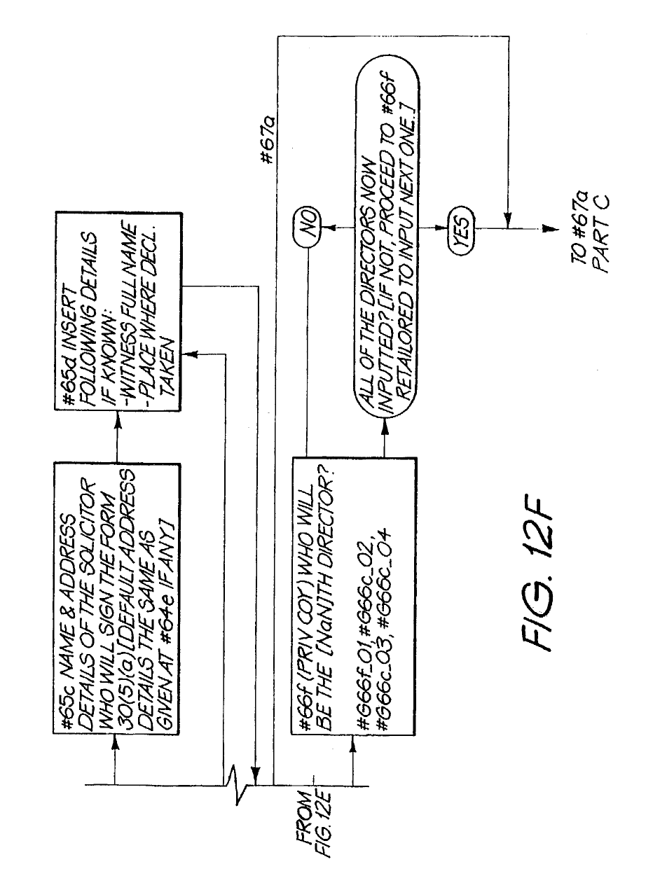

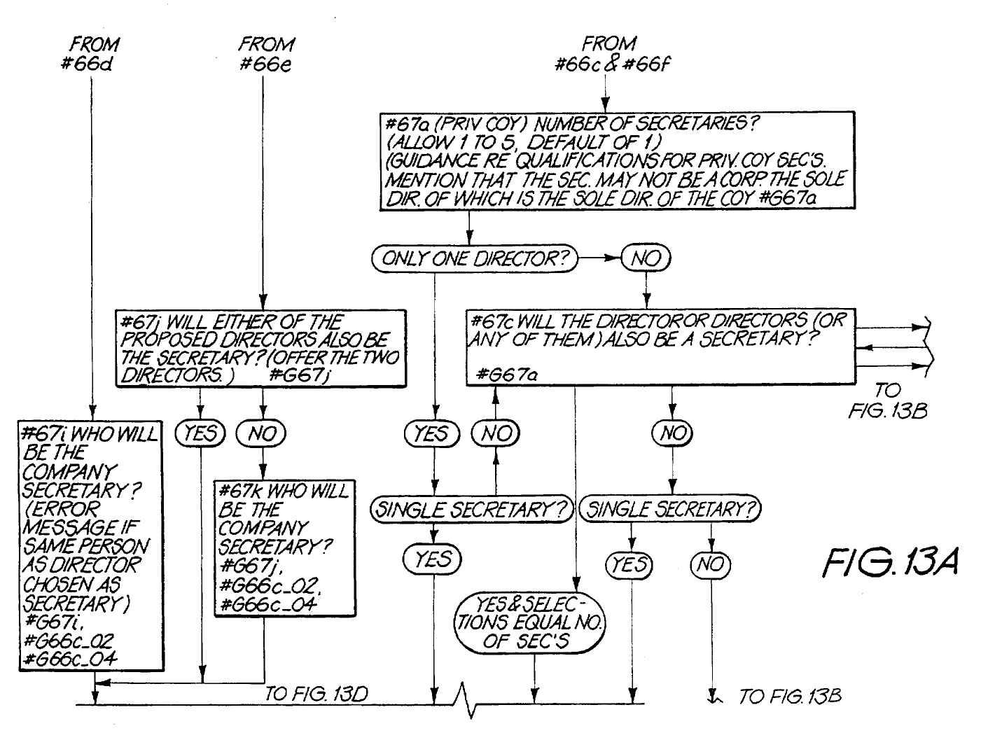

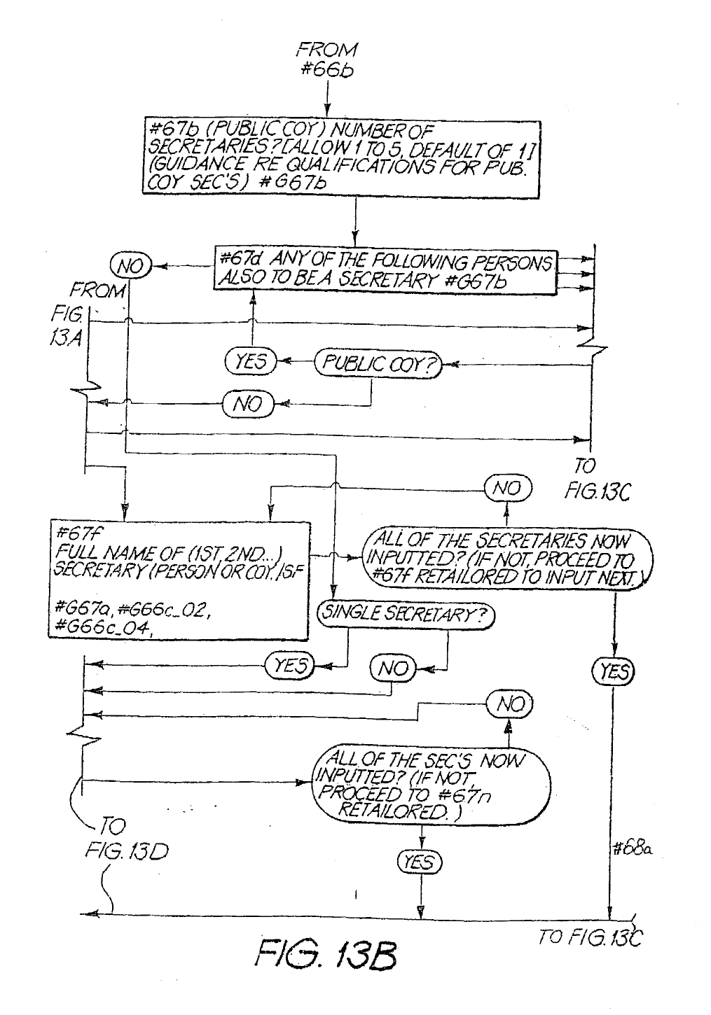

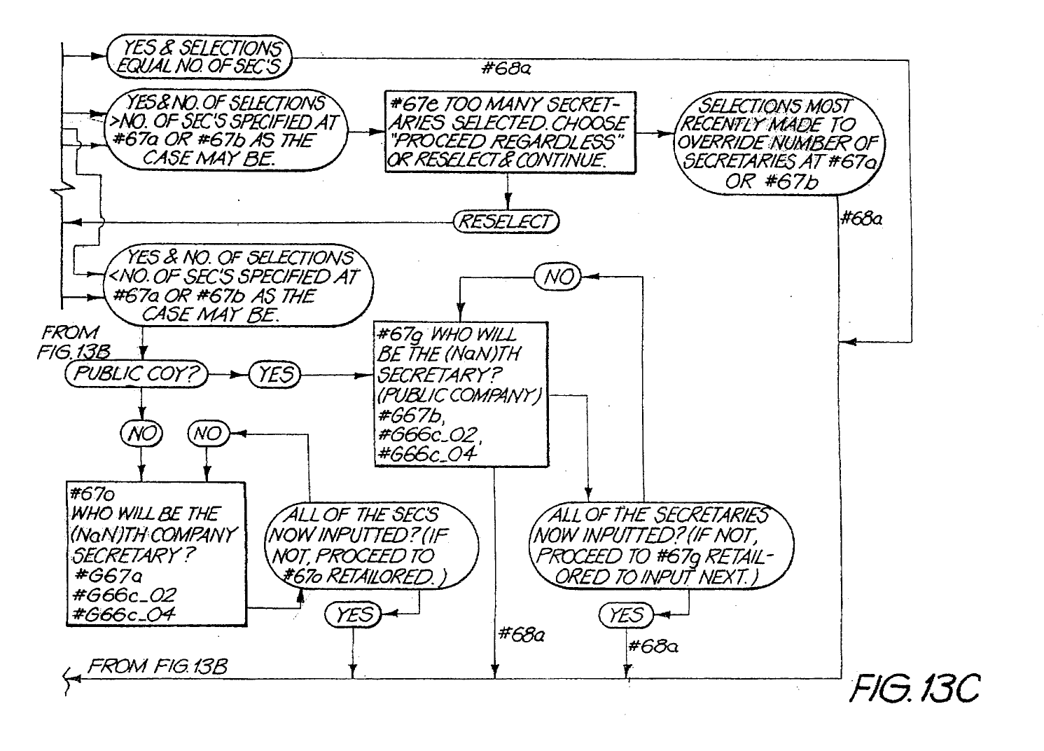

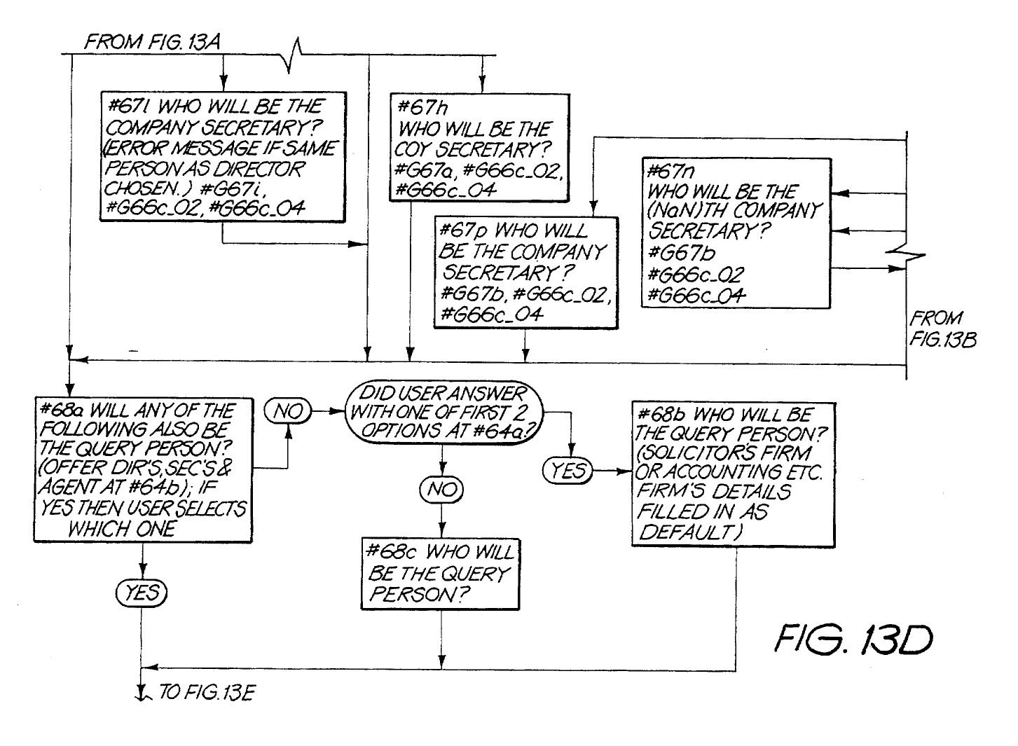

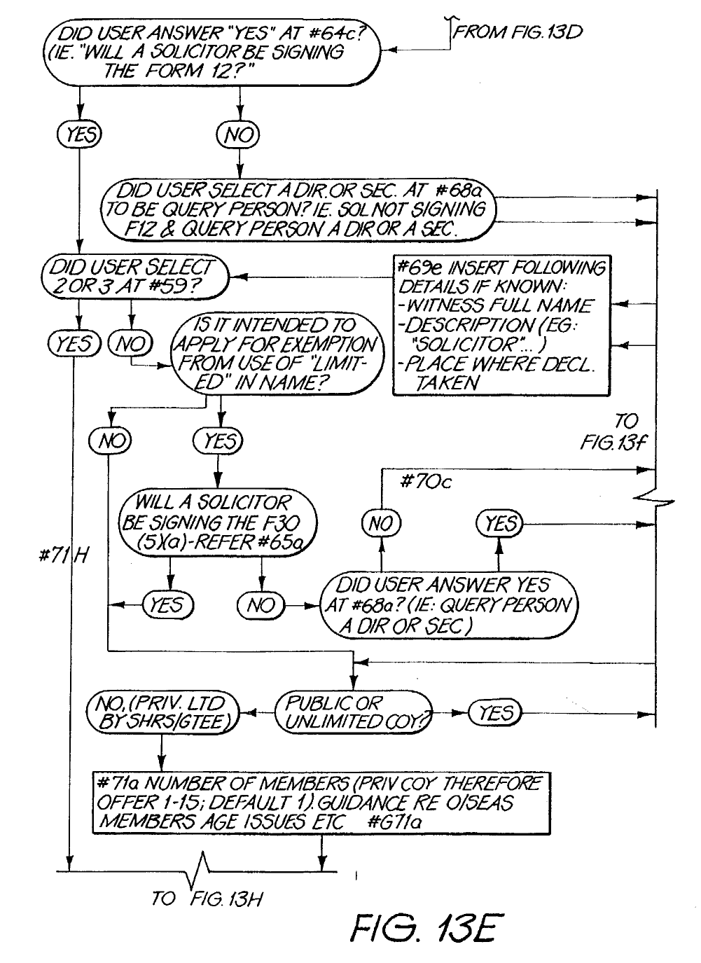

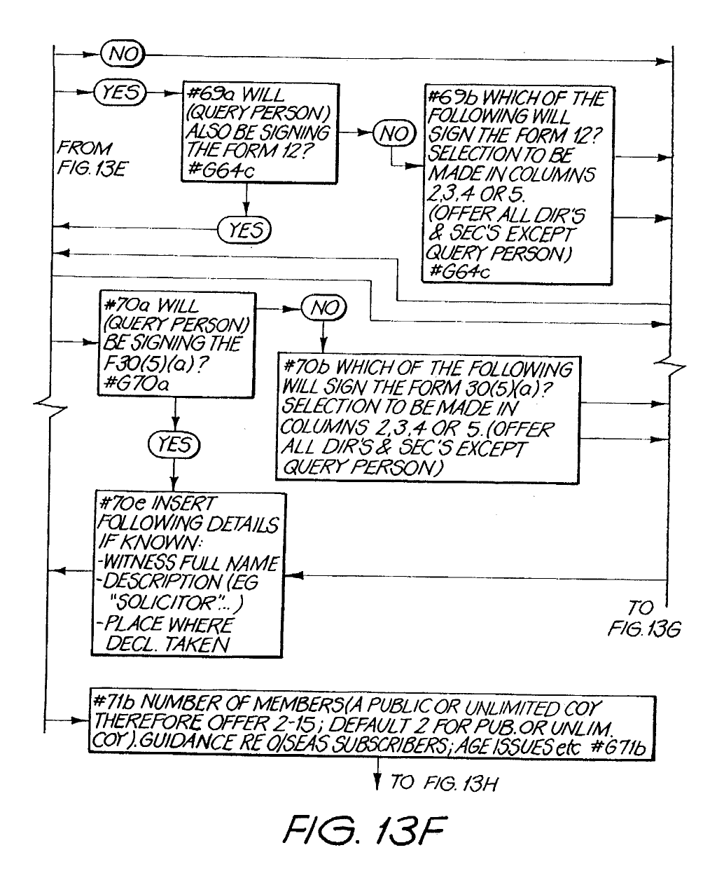

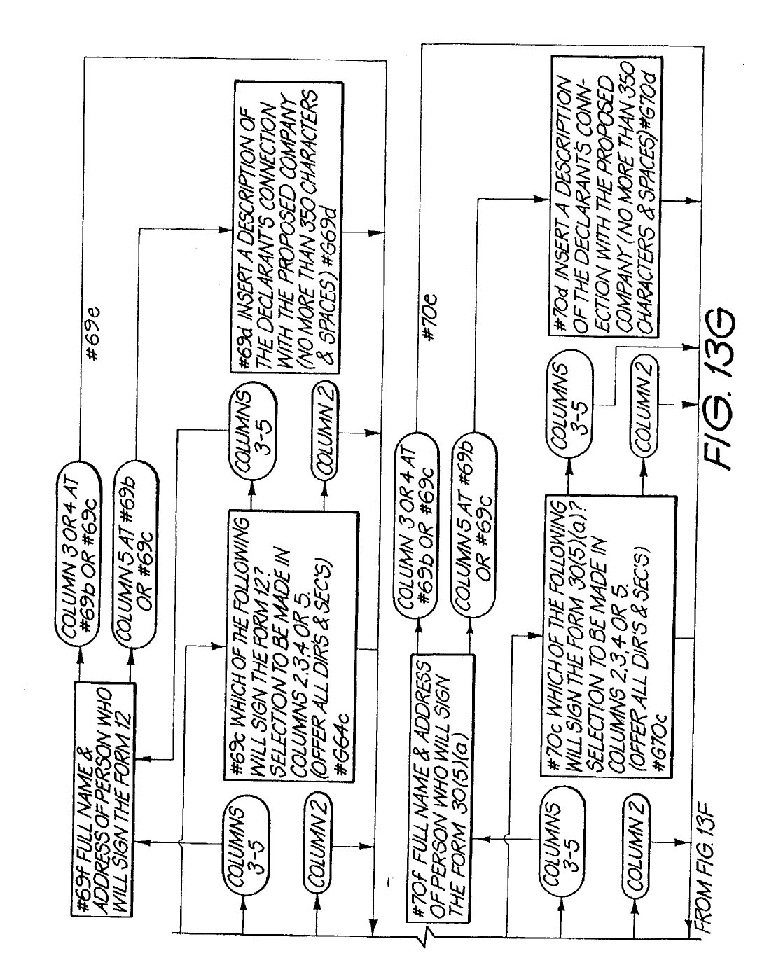

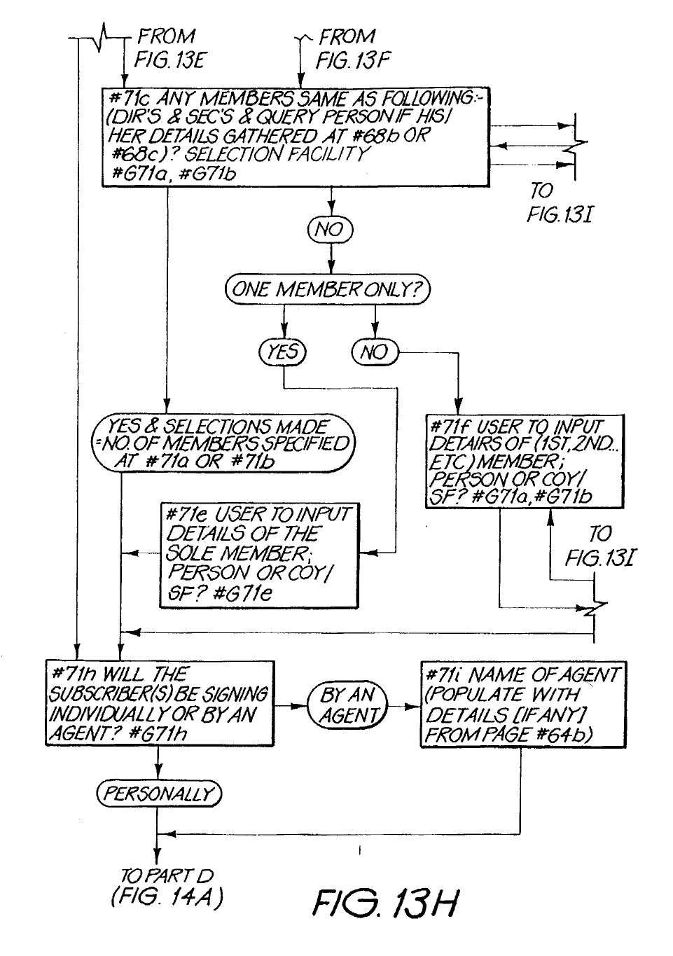

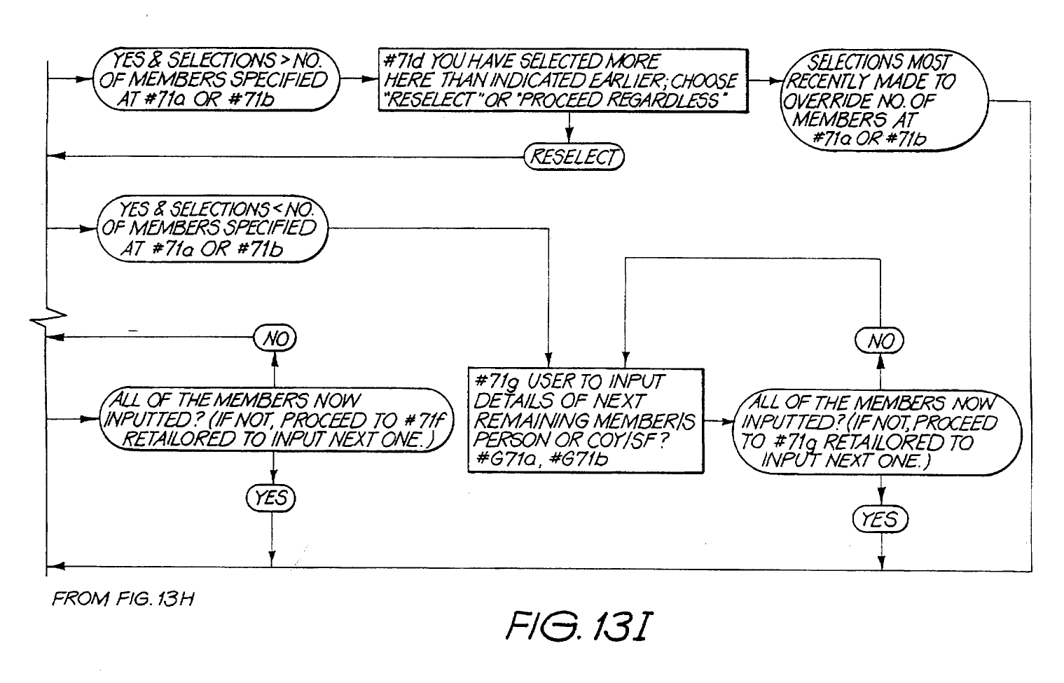

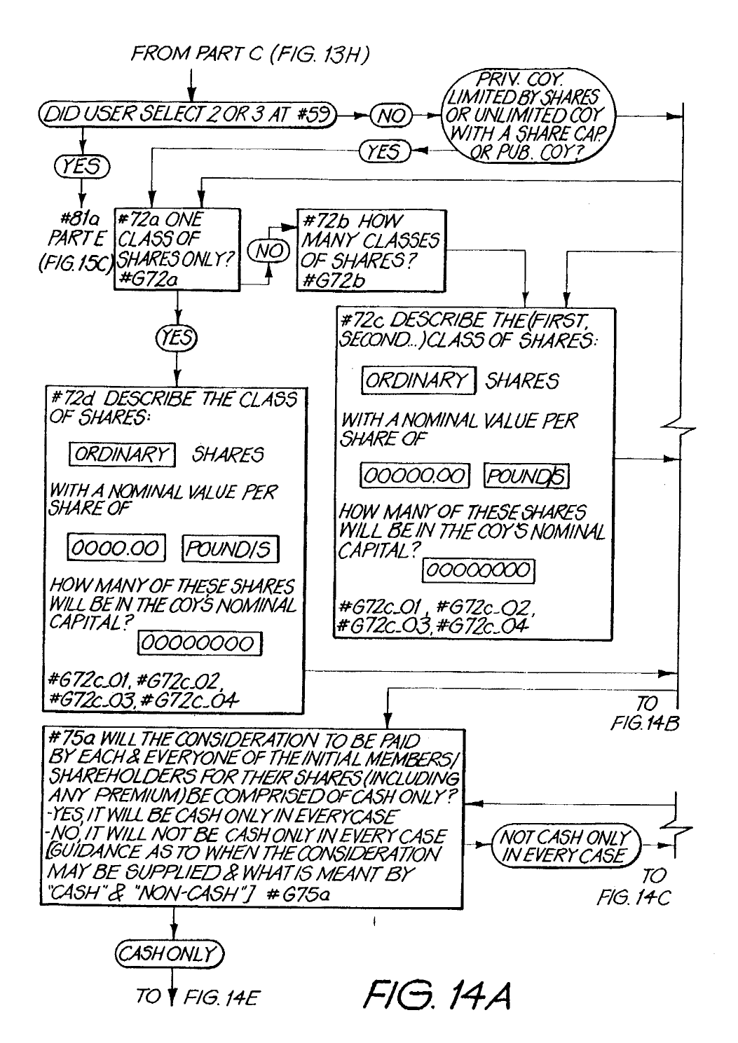

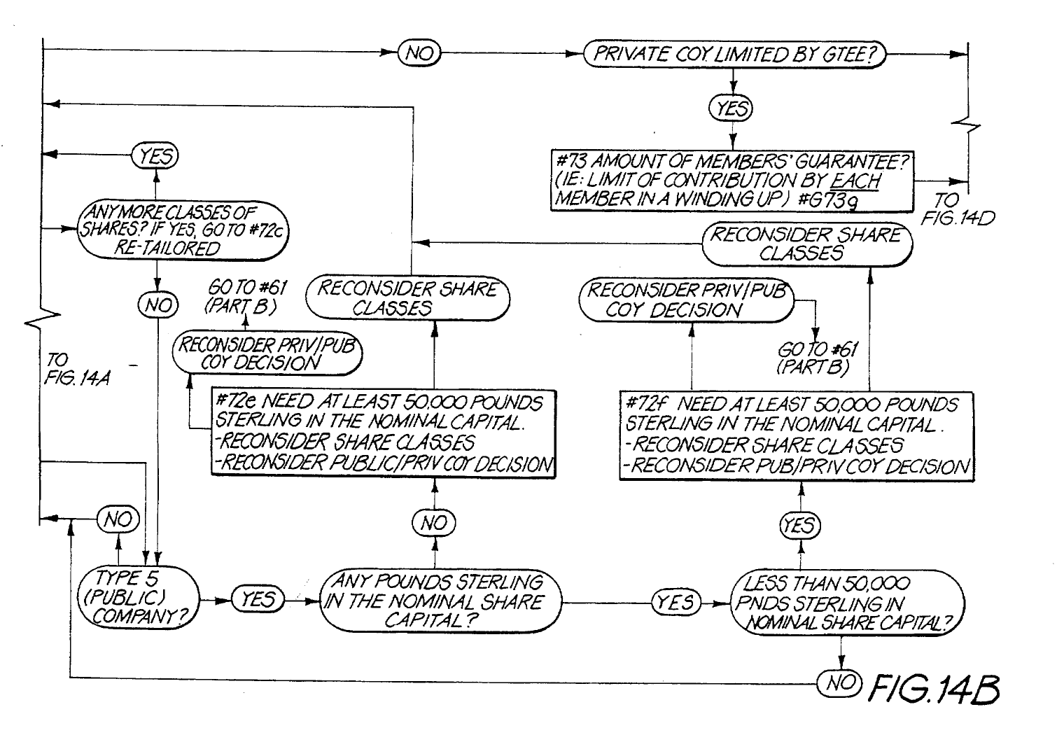

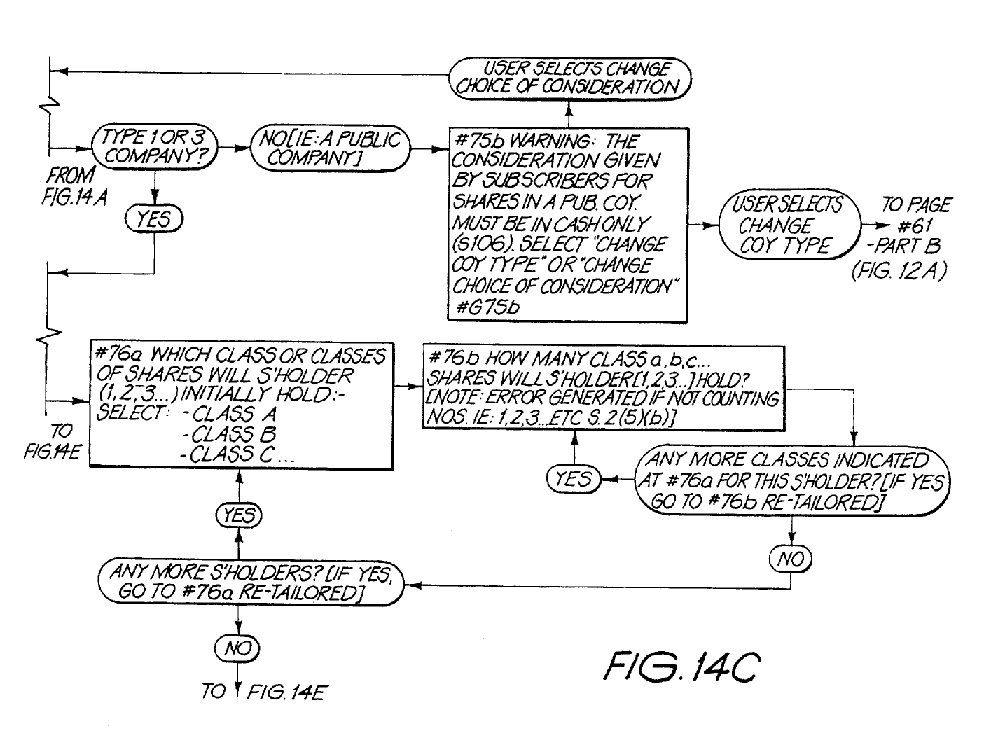

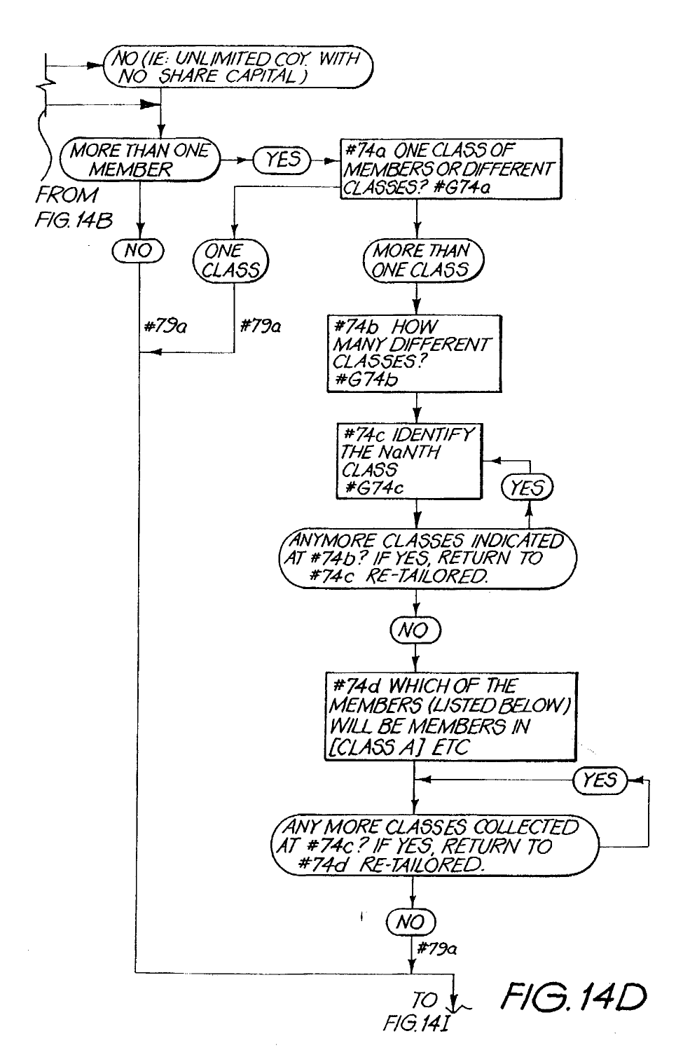

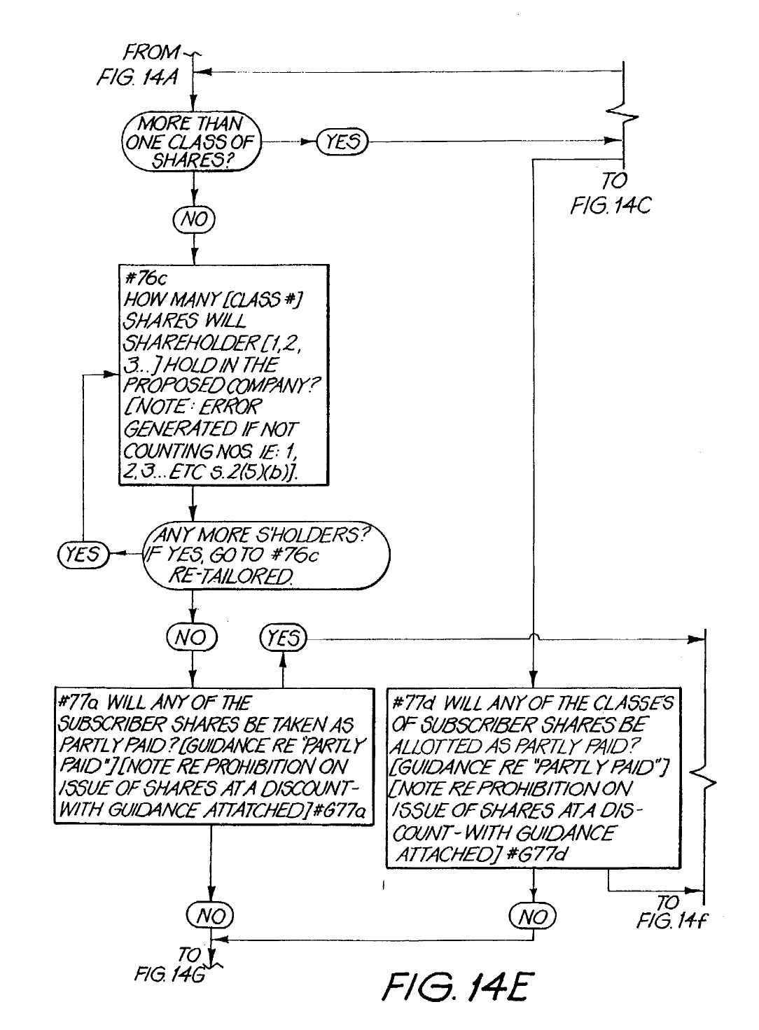

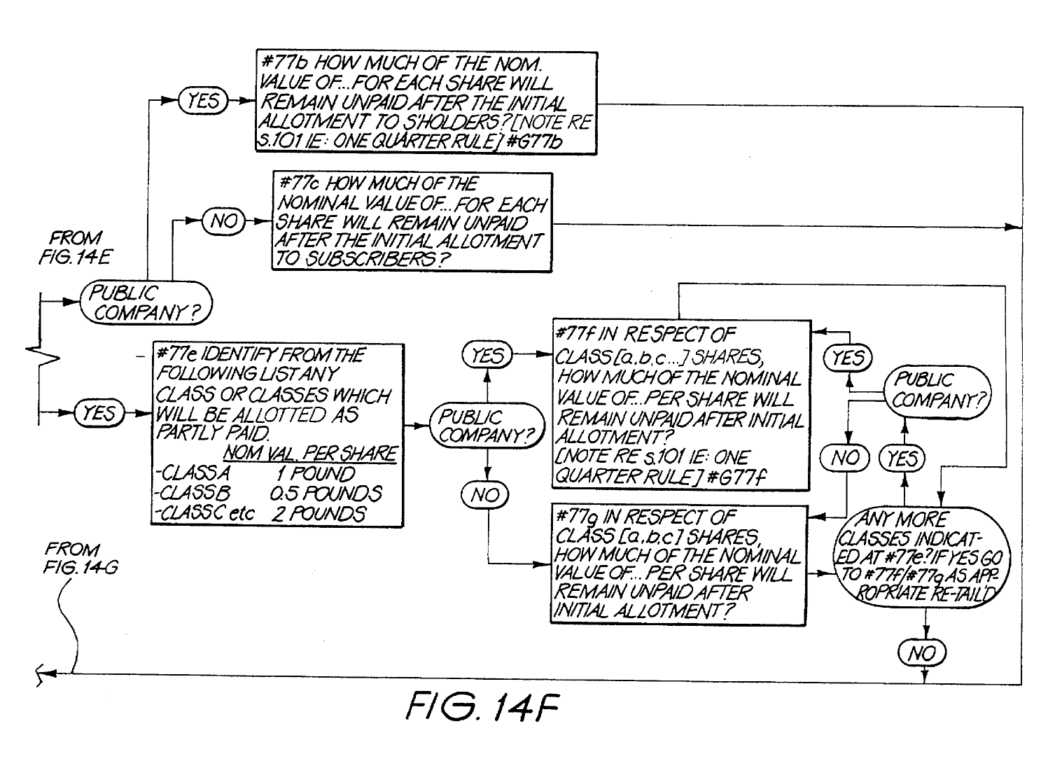

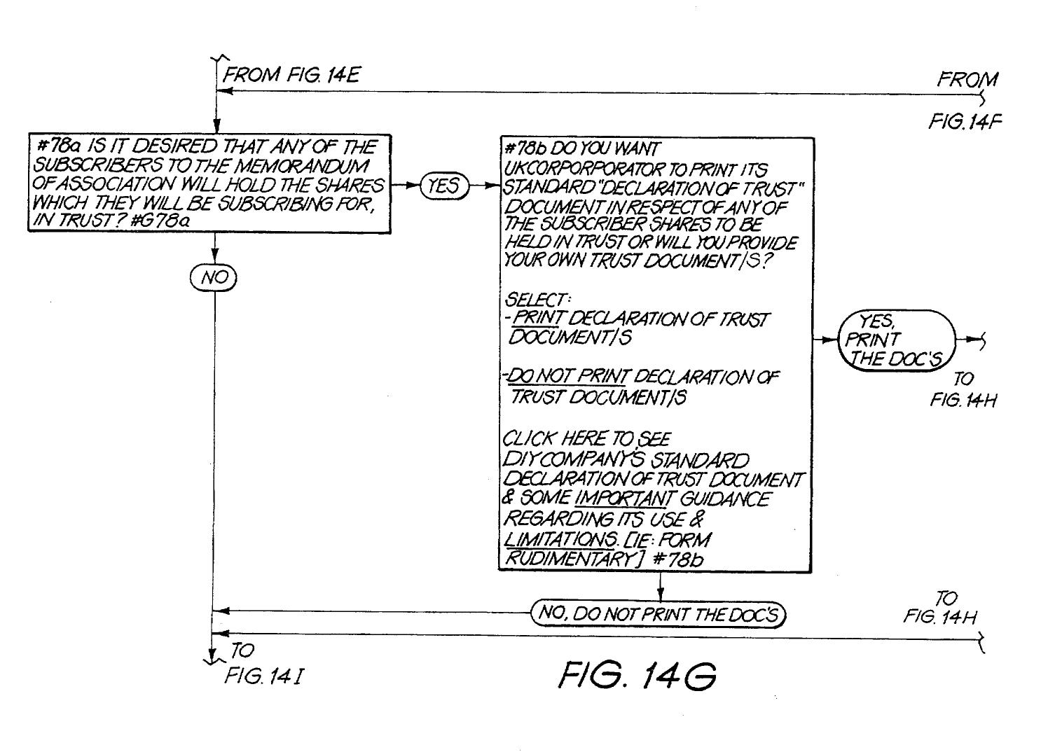

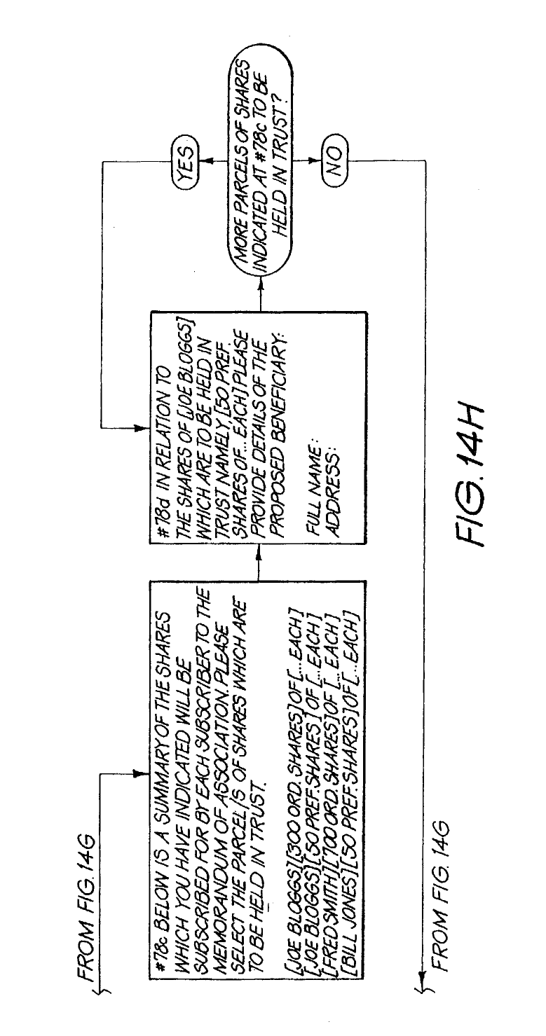

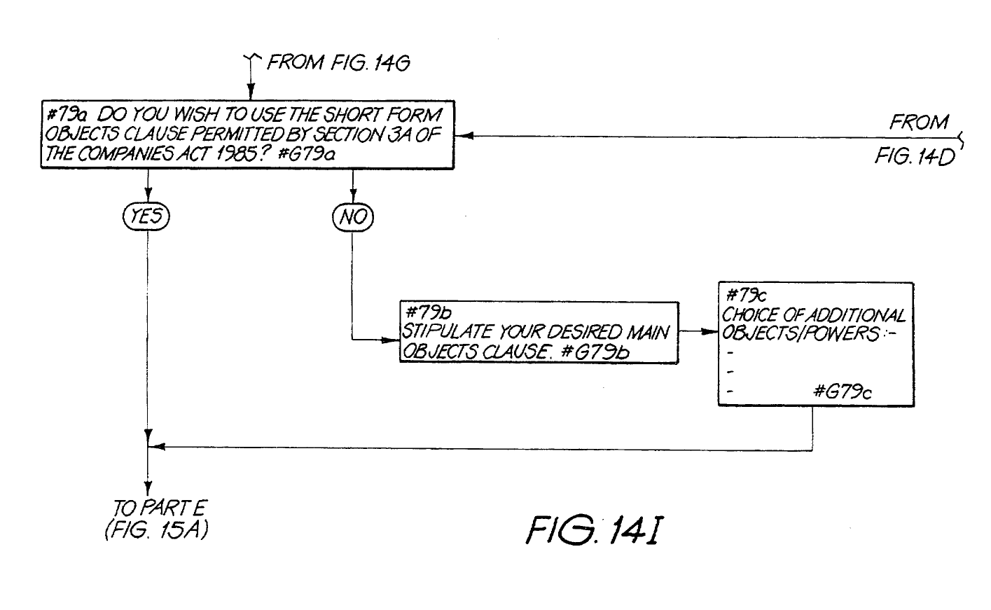

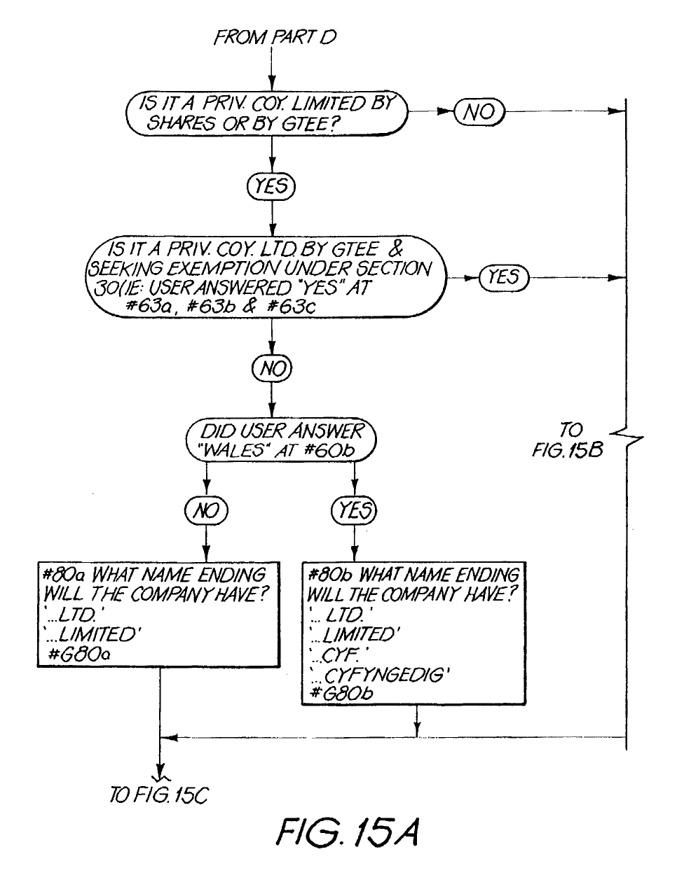

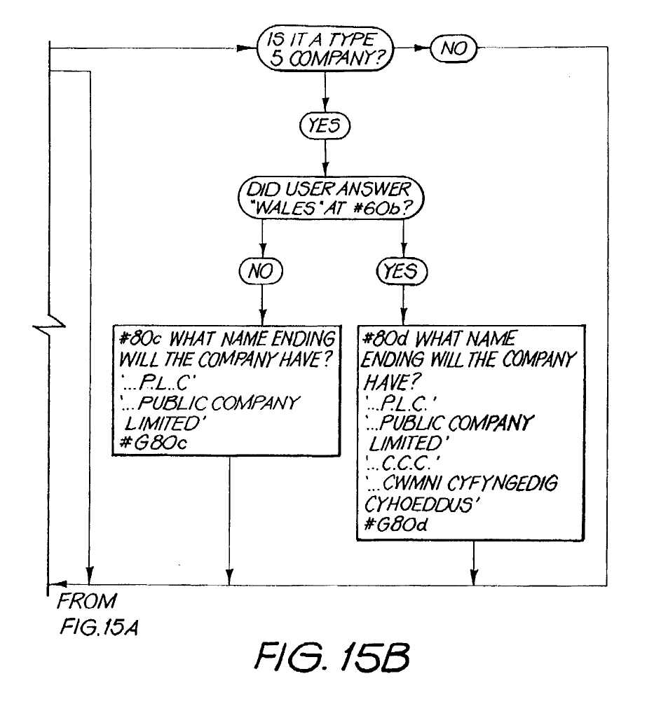

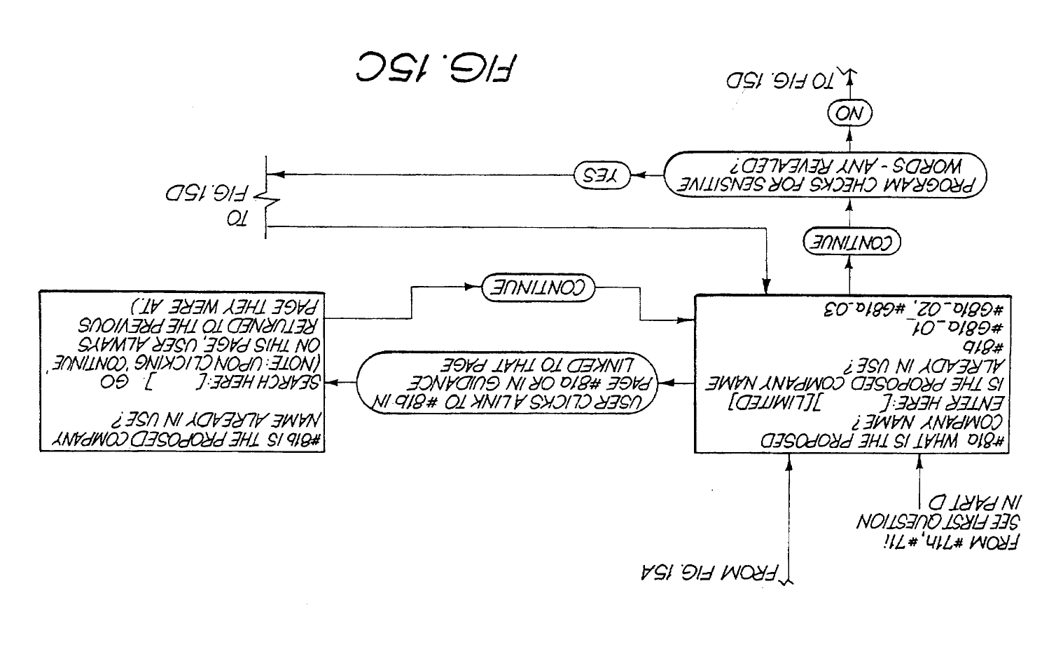

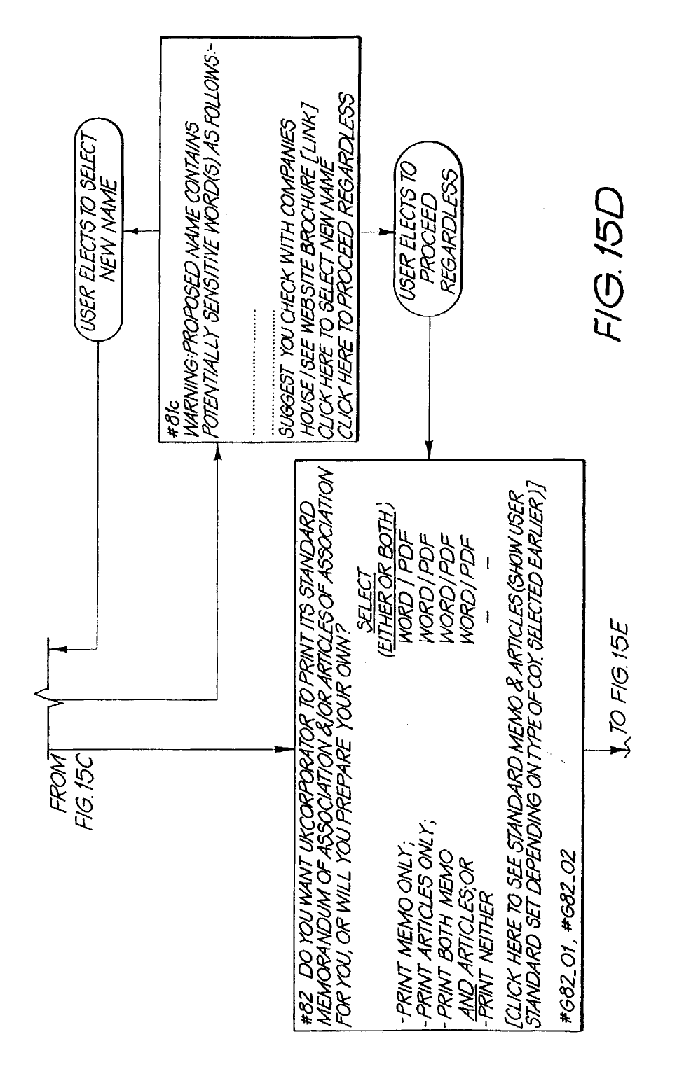

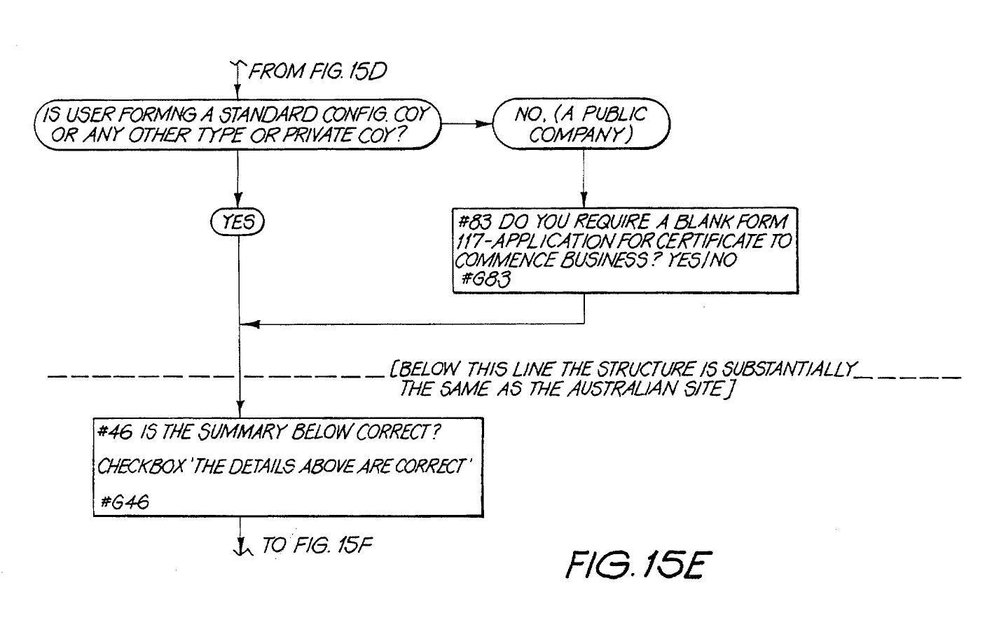

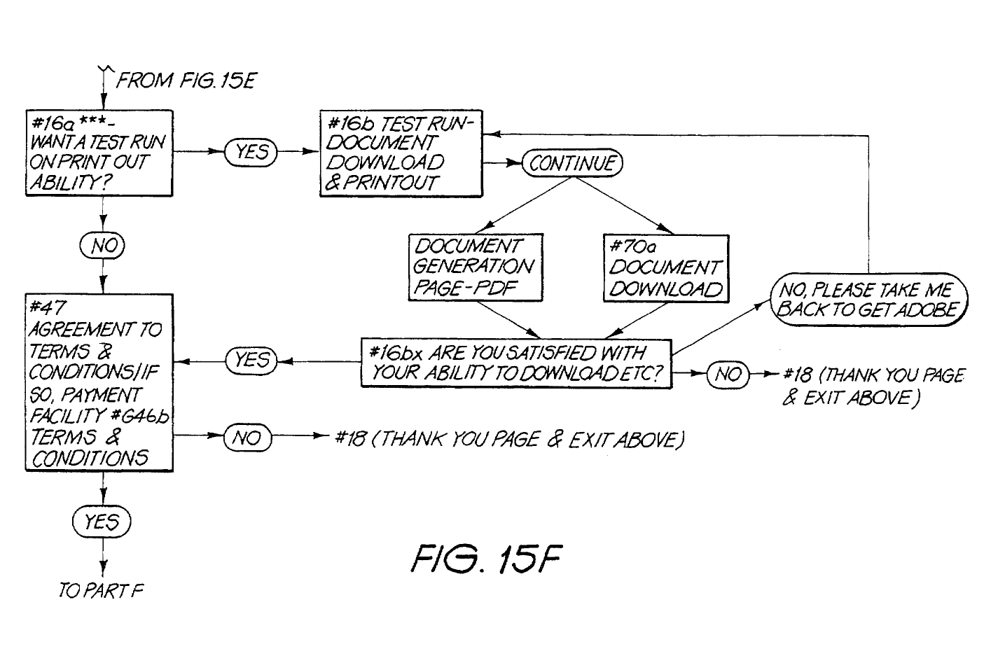

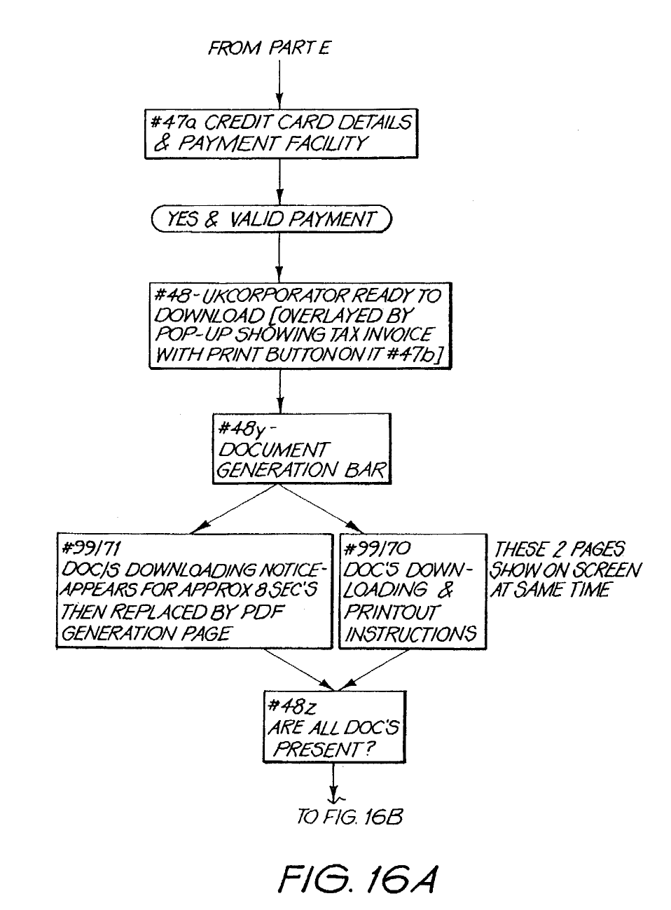

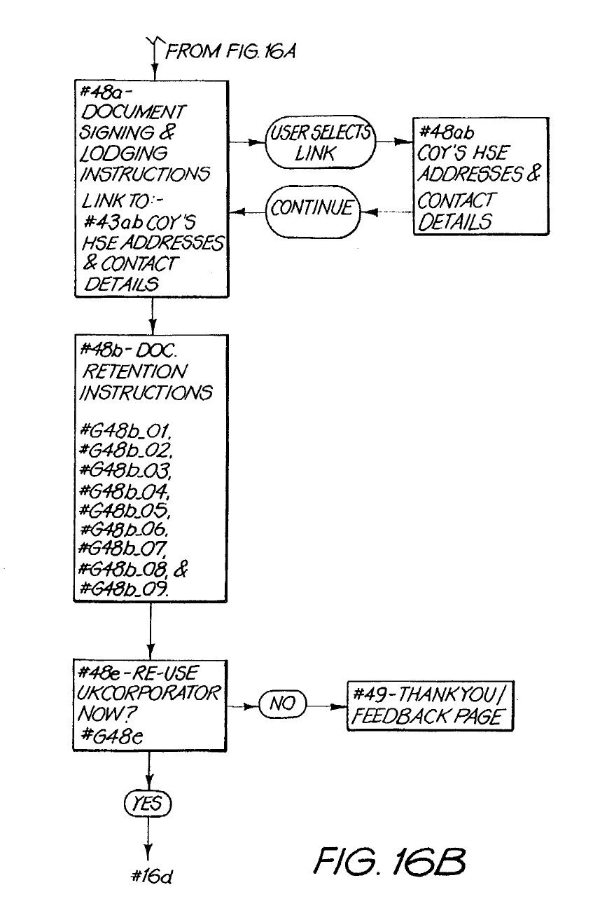

Appendix B and FIG. 11 to FIG. 16 of the drawings, again contain instructions directed to instructing a web site developer to construct a web site for the creation of the relevant documentation suitable in this instance for creating a United Kingdom corporate entity (known as UKcorporator). Again, significant background material setting out the details of the background information and explanatory material of legal concepts has been removed so as to highlight the functionality of the web site developer instructions.

It would be understood that other embodiments would be best implemented on a jurisdiction by jurisdiction basis in line with the examples presented in the attached appendices, by a team of web developers and lawyers, with the lawyers being fully conversant of the legal nuances required in the relevant incorporation documentation and the law relating to the formation of corporate entities in the relevant jurisdiction. Further, the resulting directions, questions and guidance materials themselves would no doubt evolve over time in accordance with changing statutes and changing laws and the release of information by the various regulatory authorities. It would be readily evident that by the creation of similar teams in other jurisdictions, the creation of other embodiments relevant to the creation of corporate entities within each relevant jurisdiction can be facilitated.

Turning again to FIG. 1, an example of operation of the preferred embodiment will now be explained. If for example client user 30 wishes to create a corporate entity, to do so they download a home page (not shown) of web site 21 supported by server 14. Client 30 may optionally first register their details with the CECSP 15 via a virtual form on the web site 21 (not shown). The client 30 provides their name (whether natural person or legal person), contact details and credit card details (although these can be provided at the end of the answering session thereby allowing potential users to use the majority of the site and to test it out so that they can get comfortable with it before committing themselves to payment and before disclosing their credit card details) which are all stored on the database 16.

In another embodiment, the credit card details may be stored on another database remote from and not accessible by the CECSP 15, such as a banking institution's database.

The information within the downloaded virtual form is sent via the Internet 12 to the server 14. Upon receipt of the user information, application program 20 generates a user ID and a session number for gaining access to pages within the web site 21 so that the person can begin to incorporate a corporate entity. All transmissions between the client 30 and the CECSP 15 via the Internet 12 can be encrypted using SSL encryption protocol.

In another embodiment, the application program can allow the user to select a username and password when they elect to register with the system 10. Preferably the username can be in the form of an email address and the password can be in the form of a four digit personal identification number (PIN).

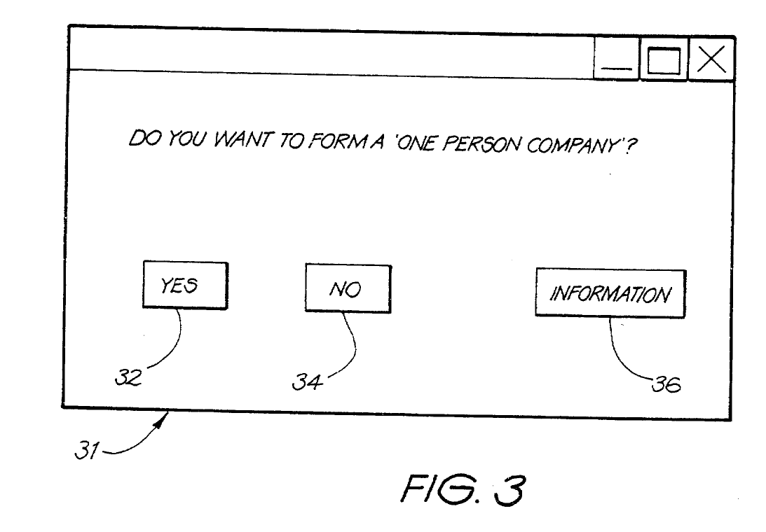

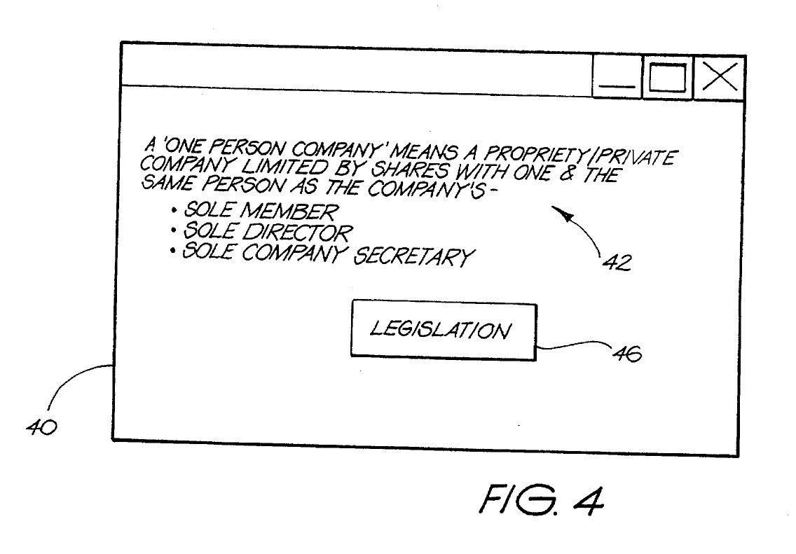

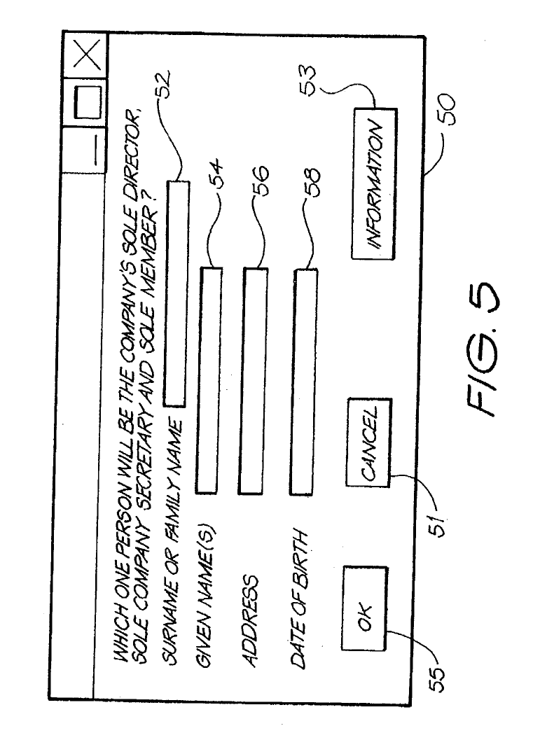

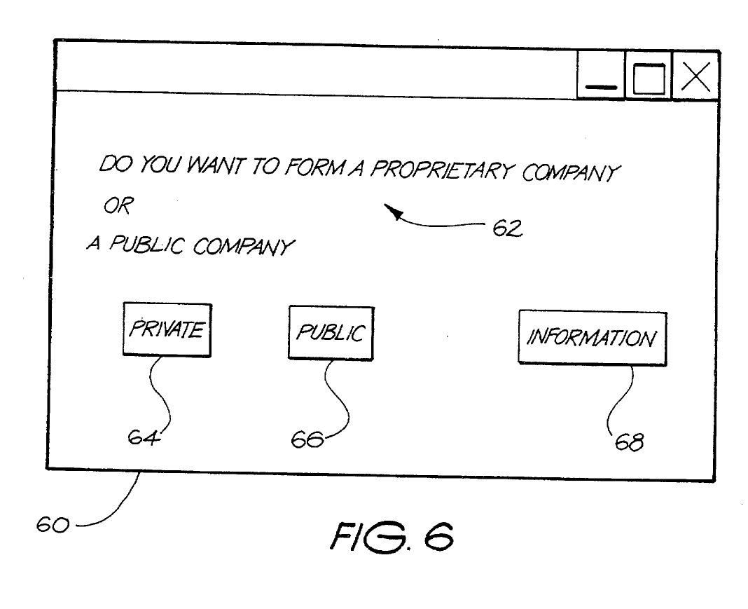

The client 30 instigates an answering session with the application program by entering their username and personal identification number (PIN) to gain access to web page 31 shown in FIG. 3. Web page 31 is downloaded from the server 14 and displayed on a browser programmed into the client PC 30.

By displaying the web page 31 to the client user 30, the application program asks the client user 30 if they want to form a “one person company”? The client user 30 then answers the application program's 20 question by either selecting the YES button 32 if they want to form a one person company or, if they don't want to form a one person company, they select the NO button 34. Alternatively, if the user is not sure what is meant by a one person company, the user can select the INFORMATION button 36.

If the user selects the INFORMATION button 36, a request is sent from client PC 30 to server 14 via the Internet 12 for a web page 40 as shown in FIG. 4. The web page 40 displays on the right side of the user's monitor and thus allows the web page 31 to remain simultaneously viewable (the text of the web page 31 is displayed on the left side of the user's monitor so that it is not obscured by the web page 40). It will be appreciated that in other embodiments a separate web page 40 may not be generated but a HTML frame, DHTML file or XML file containing the information can be provided on web page 31. In the case of a DHTML file, it may be smoothly scrolled in from the right side of the user's monitor.

The web page 40 provides information (by arrow 42) to the client user 30 as to what a ‘one person company’ means. That is, a one person company is a proprietary/private company limited by shares, wherein the company has one and the same person as the company's sole member, sole director and sole company secretary. The user has the option after reading the explanation of a one person company to go to web page 31 of FIG. 3, without selecting any BACK button, and answer the question. Alternatively, if the client user 30 wishes to view any appropriate legislation relating to a one person company then they can select the LEGISLATION button 46.

Upon selecting the LEGISLATION button 46, a request message is sent to server 14 for any relevant legislation which may relate to one person companies. The application program then instructs the server 14 to send a request for the legislation information contained within the legal resources server 22. Upon receipt, this information is then forwarded and displayed to the client 30 in a web browser page, appropriately sized and positioned so that it does not entirely obscure web page 40 (or web page 31). Once the client user 30 ‘clicks’ back anywhere in web page 31, the browser reverts to a full and ‘active’ view of web page 31. Referring again to FIG. 3, once the client user 30 has answered the question by selecting the YES button 32 or the NO button 34, the selection is sent to the server 14 and read by the application program 20. If the client user 30 selects the YES button 32, the application program 20 then instructs the CPU 19 to send web page 50, as shown in FIG. 5, to the PC 30. Referring now to web page 50 in FIG. 5, the application program 20 requests the user to enter the details of the sole director, sole company secretary and sole member by filling in dialogue boxes: surname 52, given names 54, address 56, birth details 58.

The user of client PC 30 can click on the CANCEL button 51 in which case the web page 50 disappears from the display of PC 30 and web page 31 of FIG. 3 is then shown again or alternatively, the user can select the information button 53 and be displayed a web page, like web page 40 of FIG. 4, to obtain the information relating to the details being requested at web page 50 in FIG. 5. If the user of client PC 30 selects the OK button 55, then this answer is then again sent to the server 14 and the data is read for each of the virtual forms 52, 54, 56 and 58 and the data recorded in database 16.

As the application program 20 reads the data, it also can apply two types of error checking functionality.

The first type of error checking may be described as ‘field validation’. For example, if the user of client PC 30 enters a date of birth for the proposed sole director and sole secretary indicating that the person is less than the minimum lawful age, the application program invokes a message to the client PC 30 by posting another web page (not shown) to the client PC 30 browser which indicates that, by law, a director and company secretary of a company must be a specified minimum age. The user of client PC 30 is then provided with an opportunity to amend the date of birth if it was inputted incorrectly, or propose another person who is the minimum lawful age, as the proposed sole director and sole secretary.

In another embodiment, the error checking is conducted on the ‘client side’ and the error message does not come up in the form of another web page but simply a small ‘JavaScript’ error message which ‘pops-up’. In this way the user doesn't have the delay associated with the transmission to and from the server.

In a similar fashion, other error checking features include the detection of errors such as the following (together with the displaying of an associated error message informing the client user 30 of the nature of the error and instructing the client user 30 how to remedy the error):

errors relating to the entry by the client user 30 of dates which do not exist, for example, February 29 in a non-leap year;

errors relating to the failure by the client user 30 to provide information which is legally mandatory;

errors relating to the entry by the client user 30 of a letter or letters in a field which may only validly accept the entry of digits;

errors relating to the entry by the client user 30 of an amount unpaid per share which exceeds the amount previously specified by the user as being the total amount paid per share;

errors relating to the entry by the client user 30 of a negative amount in a field which may only validly accept a positive amount (for example, the number of shares proposed to be held by a proposed shareholder);

errors relating to the entry by the client user 30 of a number with decimal places into a field which may only validly accept counting numbers, for example, the number of shares proposed to be held by a proposed shareholder;

errors relating to the entry by the user of a post office box address in circumstances where the relevant law does not allow the specification of such an address but instead requires the specification of a physical address;

errors relating to the entry by the user of a purported post code which could not be a valid post code in the relevant jurisdiction;

errors relating to the entry by the user of a foreign address in circumstances where the relevant law requires the provision of a domestic address;

errors relating to the entry by the client user 30 of an invalidly formatted email address; and

errors relating to the failure by the client user 30 to select an option in a field in a virtual form.

The second type of error checking functionality is broader and more sophisticated than the first in that its activation not only depends upon the input that the client user 30 makes on a particular web page, but also depends on a previous answer or combination of answers which the client user 30 has given. For example, in the preferred embodiment of formulating a corporate entity in Australia reproduced in Appendix A and FIGS. 7 to 10 of the drawings, if the user is forming a company limited by guarantee and has previously indicated to the CECSP 15 that the company will not have a written constitution but instead will rely entirely on the ‘replaceable rules’, but subsequently indicates to the CECSP 15 that it is proposed that the company will exclude the word ‘Limited’ or the abbreviation ‘Ltd’ from the company's name, then an error message web page will be displayed to the user indicating that this would be in breach of section 150 of the Corporations Law. The error message web page will give the user the option of either specifying that the company will have a written constitution or of opting to have the word ‘Limited’ or the abbreviation ‘Ltd’ included in the company's name. As another example, if the user provides the details of a proposed director with a foreign residential address in circumstances where this would breach the minimum number of resident directors legally required, having regard to the type of company proposed to be formed as previously specified by the user, and having regard to the number of directors previously specified by the user, and having regard to the residential addresses of the directors previously specified, the CECSP 15 will display an associated error message explaining that the user's proposal would be in breach of the law and requesting a re-specified director.

Referring now again to FIG. 3, if the client user 30 had selected the NO button 34 instead of the YES button 32, then this answer when read by the application program 20 would have resulted in another question being sent to the client user 30, the web page 60 shown in FIG. 6. Web page 60 asks a further question as to whether the user of client PC 30 would like to form a proprietary company or a public company (as shown by arrow 62). If the user of client PC 30 selects the PRIVATE button 64, a private company is selected. If the user of client PC 30 selects the PUBLIC button 66, then a public company is selected. Alternatively, the selection of the INFORMATION button 68 results in the client PC downloading (or activating on the client side) another information page (not shown) which will explain to the user, the differences between a proprietary company and a public company. The information page will also contain links to legislation shown on legal resources 22 (FIG. 1). When the user of client PC 30 selects the PRIVATE button 64 or the PUBLIC button 66, this answer is then sent to the server 14 via the Internet 12. The application program 20 again reads the answer and selects an appropriate web page dependent upon the company type selected.

The series of questions shown here in FIGS. 3 to 6 have been shown as an illustration of the steps that the application program undertakes by first reading an answer to a question and then selecting a new set of one or more questions depending upon the client user's 30 answer. The application program 20, continues to ask a new series of questions until the client user 30 has provided enough information to form the particular corporate entity that they want to form.

The logic of the web site 21, in terms of a system for creating an Australian corporate entity, is displayed in FIGS. 7 to 10 of the drawings and in Appendix A. The logic that the application program 20 follows in navigating through the web pages will generally be dependent upon the previous answer, or combinations of previous answers, that the user provides to the series of questions.

Once the application program 20 has all of the information required to form a corporate entity, the application program 20 creates and sends documents, in PDF format, to the user of client PC 30. The user of client PC 30 can then access these documents by using real display software such as provided by Adobe Acrobat Reader™ developed by Adobe Systems Incorporated. The client user 30 can then print out the documents from their printer (not shown) connected to client PC 30 and lodge those documents that constitute the application documents by post or by courier or in person, with the Corporate Entity Registration Authority 25 as the application for registration of a corporate entity.

The requisite documents can be produced by the insertion of text fields generated into prepared template documents (such as word documents or PDF documents) in a mail merge type operation.

Each web page referred to in the logic diagram of FIG. 7 to FIG. 10 is reproduced in Appendix A. Together they show a preferred embodiment of a web site for formulating a corporate entity in Australia as at Mar. 12, 2000. Likewise FIG. 11 to FIG. 16 and Appendix B together show a preferred embodiment of a web site for formulating a corporate entity in the United Kingdom under that country's current law.

Alternatively, rather than forwarding all the PDF documents directly to the client PC 30, in another embodiment the application program 20 generates an electronic file containing the information for an application to register the proposed corporate entity and transmits this data to the Corporate Entity Registration Authority 25's server 24. The Corporate Entity Registration Authority is usually a government administrative body and registers the company based upon the information provided. The CECSP 15 can be paid for the services it provides. The user of client PC 30 provides their credit card details to provide payment for the services CECSP provides. Other payment systems may also be utilized such as bill payment or telephone banking payments or even a cheque sent to the CECSP 15.

It will be appreciated that the application program 20 can be implemented so that all the necessary documents are generated and so that unnecessary documents are not generated when creating a corporate entity. For example, if the user of client PC 30 does not propose that the company will have a company secretary, then the application program 20 will not generate a form of consent to act as a company secretary. If the user of client PC 30 proposes that the company will have a board of 12 directors, the application program 20 will generate 12 individual consents to act as a director, each in the name of the relevant proposed director. If the user is proposing to form an Australian company limited by guarantee, the application program 20 knows that a newly formed Australian company limited by guarantee will not have shareholders but will only have members, and therefore generates consents to become members without associated agreements to take up shares and does not complete shareholding details in the register of members (as it would for other types of companies); the system also generates the associated members' guarantees.

The application program 20, in order to make the answering session as convenient and non repetitive as possible for the user of client PC 30, frequently allows the user to specify, as an answer to a question, details of a previous answer which apply equally to the current situation. For example, after gathering details of the proposed director(s), on turning to the task of gathering details of the proposed company secretary(s) the application program 20 does not simply ask “Who will be the company secretary(s)?”. Instead the application program 20 first gives the user the opportunity of specifying any previous person mentioned as being the/one of the company secretary(s) thereby avoiding the need for the user to re-type all the relevant details for the relevant person(s), namely, full name(s), address(es), date(s) of birth etc.

Furthermore, the application program 20 can have a “standard company configuration feature” which allows a user of client PC 30 to specify a standard or commonly used company configuration (ie such as a “one person company”). Based on the specified standard configuration, the application program 20 assumes a set of standard answers to questions which would otherwise be asked. This avoids the need for the user to re-input identical details, or at least re-confirm identical details, at various stages of the process. It also reduces the number of questions which the application program 20 needs to ask a user of client PC 30, thereby making the questioning process quicker and more convenient.

Application program 20, in order to allow the user of client PC 30 to be sure that the user is not choosing a legally unavailable name for the proposed corporate entity, provides a link to the database maintained by the Corporate Entity Registration Authority 25 of names of corporate entities which are already used by existing corporate entities and thus are not available to be used by the proposed corporate entity, or to the corporate entity name availability function maintained by the said Corporate Entity Registration Authority 25. Application program 20, in order to decrease the likelihood of errors inputted by the user of client PC 30 going unnoticed by the user, has a function called “View Summary So Far”. This function allows the user, having reached a point in the answering session, where the application program 20 has collected sufficient information to make a sensible and coherent summary of the information inputted by the user up to that point, to view a summary of all or key information that has been provided up to that point. This information is recalled from the database 16. By reviewing this summary, the user can see whether the user has incorrectly inputted any information or whether the system has “misunderstood” the user in any way. If any such mistakes are apparent, the user may then advise the system of the correction. In the current embodiment, the user makes the correction by going back to the page at which the incorrect information has been entered. In another embodiment, the user may correct errors directly at the actual “ . . . Summary So Far” web page. At the end of the process and before finalising the information which has been provided by the user in the answering session, the user also confirms that the summary of information entered is correct. Again, if any mistakes are apparent, the user may then similarly advise of any corrections.

Additionally, because the user's profile is saved by the application program in the database 16, the user can terminate an answering session and continue on with another answering session at a later time. Furthermore, the user can save their inputs for future use if they wish to use this information in order to form another corporate entity. The user may elect to do this for two advantageous reasons. First, so that the user may reassess the information entered on the user's then current usage of the system, on a future use of the system for the purpose of forming another corporation (it may be that a lot of the information the user inputs on the user's then current usage will be the same as that proposed to be inputted on a future usage—for example, the applicant and lodging party's details, in the case of lawyers and shelf company providers who frequently form corporations—such information may be accessed as the default information on a future usage). Secondly in a case where the user's answering session with the application program 20 is accidentally terminated mid stream (say due to an Internet service provider malfunction) the current summary information can be stored so that the user won't have to re-type any information entered during the terminated answering session.

It will be appreciated that the application program and the system and method of the preferred embodiment allow members of the public, such as users of client PC 30, 33, who may be non legally qualified or paralegals, to access and interact with the application program 20 whereby they can create the documents necessary for the creation of corporate entities while being provided with related legal information. Additionally, the application program 20 provides these users with documents that have been legally based upon the answers provided by the users. This provides a number of advantages over having to seek the advice of a legal practitioner or corporate entity provider thereby alleviating the problem of having to pay legal fees or corporate entity provider fees. Additionally, legal practitioners and corporate entity providers themselves can use the application program 20. Further, they may do so with the help of lesser qualified and therefore lower paid employees, thereby saving overheads and either increasing their profit, or lowering their prices and increasing their ability to compete.

Further modifications to the preferred embodiment are possible. For example, the option may be provided to insert third party branding details into the documentation. This can be provided by allowing for the insertion of a field within the header or footer of each page.

Another advantage provided by the preferred embodiment is that information is constantly updated on the system as it is in data communication with the legal resources server 22 which is itself constantly updated. Additionally, as law and its practice is dynamic, details of web pages on web site 21 can be altered to reflect changes in the relevant law or practice thereby providing to users of the CECSP 15, the most operational of service.

It will be appreciated that other embodiments could be used to implement the invention. For example, the application program 20 could be on a CD ROM and sent out periodically to customers who would then use the CD ROM to answer questions in order to incorporate a corporate entity. Updates of the application program 20 could then be sent out in newer versions of the CD ROM.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention. Modifications, obvious to those skilled in the art can be made thereto, without departing from the scope of the present invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed:

1. A method for assisting in the formation of a corporate entity, in at least one answering session, by providing a processor means in interactive communication with a user attempting to form said corporate entity, said processor means being configured to perform automatically the following:
(a) communicating at least one set of one or more questions to said user via an interactive communications device and enabling said user to provide, for storage, one or more answers to said communicated questions;
(b) selecting a further set of one or more questions for communication to said user, wherein the selection of at least one question in said selected further set of one or more questions is dependent upon said user's answer to one or more previous questions;
(c) communicating said further set of one or more questions to said user and enabling said user to provide, for storage, one or more answers to said further set of communicated questions;
(d) repeating at least some of the above until said user has provided at least enough information to allow said processor means to determine the documents that are legally required for the formation of said corporate entity, wherein at least one repetition includes a repetition of (b) and (c);
(e) determining the documents that are legally required for the formation of said corporate entity; and
(f) generating said legally required documents referred to in (e) in an electronic form.

2. A method as claimed in claim 1 which includes storing said user's one or more answers to said questions in a database structure associated with said processor means.

3. A method as claimed in claim 1 in which one or more document templates are accessible by said processor means, and (f) includes:
selecting at least one document template corresponding to at least one of said documents determined in step (e); and
populating said at least one selected document template with one or more of said user's stored answers.

4. A method as claimed in claim 3 in which at least one of said user's stored answers is mapped to at least one corresponding text insertion area contained in said at least one selected document template to populate said at least one selected document template.

5. A method as claimed in claim 1 wherein at least once during the performance of the method the selection of at least one of said questions in said selected further set of one or more questions made in step (b) is dependent upon said user's answer to at least two previous questions.

6. A method as claimed in claim 1 wherein said documents legally required for the formation of the corporate entity include the documents required to be in existence shortly after the incorporation of the corporate entity.

7. A method as claimed in claim 1 including generating execution, lodgement and/or retention instructions for said generated documents.

8. A method as claimed in claim 1 including delivering said legally required documents to a user in an electronic form.

9. A method as claimed in claim 1 wherein said method includes enabling said user to access at least one of legally-based and/or practice-based information relating to said communicated questions.

10. A method as claimed in claim 9, wherein at least part of said legally-based and practice-based information relating to said communicated questions is communicated to said user with said communicated questions.

11. A method as claimed in claim 9 wherein said user is provided with one or more hyper links to enable said user to access at least part of said legally-based and practice-based information.

12. A method as claimed in claim 1 wherein said user answers said communicated questions from a client computer on a network.

13. A method as claimed in claim 1, wherein said questions communicated to said user are dynamically updated depending upon changes in law and practice.

14. A method as claimed in claim 1, including communicating to said user, for review, a summary including his or her answers to at least a subset of previously communicated questions.

15. A method as claimed in claim 14 in which communicating to said user, for review, a summary including his or her answers to at least a subset of previously communicated questions is performed once said processor means has received enough information to determine said documents that are legally required for the formation of said corporate entity.

16. A method as claimed in claim 14, which further includes enabling said user to amend his or her answers contained in said summary.

17. A method as claimed in claim 1 including validating the answers to said communicated questions received from said user.

18. A method as claimed in claim 17, which further includes communicating an error message to said user if an answer received to a question must by its nature be incorrect.

19. A method as claimed in claim 1 including:
allocating an identifier to identify an answering session performed by said user; and
associating said user's stored answers from said answering session with said identifier.

20. A method as claimed in claim 1 including enabling said user to submit an identifier to identify at least one of said user and an answering session.

21. A method as claimed in claim 20 including:
retrieving said user's stored answers from a previous answering session based on the submitted identifier.

22. A method as claimed in claim 1 including:
enabling said user to use at least one stored answer from a previous answering session to answer corresponding questions of a current answering session.

23. A method as claimed in claim 1 in which at least one of said sets of one or more questions includes only one question.

24. A method as claimed in claim 1 wherein in (d) a final repetition ends in a repetition of (a).

25. A method as claimed in claim 1 in which the processor means communicates all of the questions of a set of questions having more than one question to the user substantially simultaneously.

26. A system for assisting in the formation of a corporate entity in at least one answering session, said system including:
a processor in interactive communication with a user attempting to form said corporate entity;
interactive communication means, in communication with said processor, adapted to allow said processor to communicate sets of one or more questions to said user and to allow said processor to receive said user's answers to said communicated questions;
a data storer associated with said processor means configured to store said user's received answers;
said processor running an application program configured to cause said processor to communicate at least one set of one or more questions to said user and to receive answers thereto from said user; to successively select and communicate a further set of one or more questions to said user and to receive answers thereto from said user; and to repeat said selection and communication of further sets of one or more questions until said processor has received at least enough answers from said user to allow said processor to determine the documents that are legally required for the formation of said corporate entity, wherein the selection of at least some of said further sets of one or more questions by said processor is based on said user's answer to one or more previous questions;
said application program further causing said processor to determine the documents that are legally required for the formation of said corporate entity; and to generate said legally required documents in an electronic form using at least some of said user's stored answers.

27. A system as claimed in claim 26 in which said data storer includes a database structure associated with said processor, said database structure having a plurality of user answer fields in which at least selected ones of said user's answers are stored.

28. A system as claimed in claim 27 in which said database structure additionally includes a question database from which said communicated questions are selected by said processor.

29. A system as claimed in claim 26 in which one or more document templates are accessible by said processor, and wherein said application program causes said processor to merge at least one selected document template corresponding to said legally required documents, with at least a subset of said user's stored answers to generate said legally required documents.

30. A system as claimed in claim 29 in which said application program causes said processor to map said user answer fields, to corresponding text insertion areas contained in said at least one selected document template.

31. A system as claimed in claim 30 in which at least one of said user answer fields are mapped to a plurality of corresponding text insertion areas in said at least one selected document template.

32. A system as claimed in claim 26 in which said application program causes said processor to select at least one of said further sets of one or more questions on the basis of said user's answers to at least two previous questions.

33. A system as claimed in claim 26 wherein a final set of one or more questions selected by said processor includes one or more predetermined questions.

34. A system as claimed in claim 26 in which the processor communicates all of the questions of a set of questions having more than one question to the user substantially simultaneously.

35. A computer memory storing thereon an application program for controlling the operation of a processor to assist in the formation of a corporate entity in at least one answering session, said application program controlling said processor to:
(a) communicate at least one set of one or more questions to said user and enable said user to provide, for storage, one or more answers to said communicated questions;
(b) select a further set of one or more questions for communication to said user, wherein the selection of at least one question in said selected further set of one or more questions is dependent upon said user's answer to one or more previous questions;
(c) communicate said further set of one or more questions to said user and enable said user to provide, for storage, one or more answers to said further set of communicated questions;
(d) repeat at least some of the above until said user has provided at least enough information to allow said processor to determine the documents that are legally required for the formation of said corporate entity, wherein at least one repetition includes a repetition of (b) and (c);
(e) determine the documents that are legally required for the formation of said corporate entity; and
(f) generate the legally required documents referred to in (e) in an electronic form.

36. A computer memory as claimed in claim 35, wherein the application program controls said processor means to communicate to said user, legally-based and practice-based information relating to said questions as said questions are communicated to said user.

37. A computer memory as claimed in claim 35, wherein the application program controls said processor means to dynamically update the questions available for communication to said user depending upon changes in at least one of the law and practice.

38. A computer memory as claimed in claim 35, wherein said application program controls said processor to communicate to said user, for review, a summary including his or her answers to at least a subset of previously communicated questions.

39. A computer memory as claimed in claim 38, wherein said application program controls said processor to communicate said summary once said processor has received enough information to determine said documents that are legally required for the formation of said corporate entity.

40. A computer memory as claimed in claim 38, wherein said application program controls said processor means to enable said user to amend his or her answers contained in said summary.

41. A computer memory as claimed in claim 35, wherein said application program controls said processor means to update said user's stored answers upon amendment by said user to an earlier stored answer.

42. A computer memory as claimed in claim 35, wherein said application program controls said processor to validate answers received from said user and to communicate an error message to said user when said user provides an answer which must by its nature be incorrect.

43. A computer memory as claimed in claim 35, wherein said application program controls said processor to allocate a unique identifier to identify each answering session.

44. A computer memory as claimed in claim 35, wherein said application program controls said processor to copy at least one of said user's stored answers from a previous answering session to enable said user to use said at least one copied answer in a current answering session.

45. A computer memory as claimed in claim 35 wherein said application program controls said processor to create an electronic file, that is representative of at least a subset of said user's stored answers, for filing with a registration authority that registers corporate entities.

46. A computer memory as claimed in claim 35 wherein said application program controls said processor to communicate all of the questions of a set of questions having more than one question to the user substantially simultaneously.

47. A computer memory as claimed in claim 35 in which said documents legally required for the formation of the corporate entity include the documents required to be in existence shortly after the incorporation of the corporate entity.

48. A system as claimed in claim 26 in which said interactive communications means includes a computer network.

49. A system as claimed in claim 26 in which said documents legally required for the formation of the corporate entity include the documents required to be in existence shortly after the incorporation of the corporate entity.
